(19) United States
(12) Patent Application Publication
(10) Pub. No.: US 2025/0310762 A1
(43) Pub. Date: Oct. 2, 2025

(54) Reuse of Security Context for Access and Registration

(71) Applicant: Telefonaktiebolaget LM Ericsson (publ), Stockholm (SE)

(72) Inventors: Vesa Lehtovirta, Espoo (FI); Cheng Wang, Shanghai (CN); David Castellanos Zamora, Madrid (ES)

(21) Appl. No.: 18/863,481

(22) PCT Filed: Jun. 9, 2023
(86) PCT No.: PCT/EP2023/065522

§ 371 Date: Nov. 6, 2024

(30) Foreign Application Priority Data
Jun. 20, 2022 (WO) PCT/CN2022/099894

(51) Int. Cl. H04W 12/06; H04W 12/0431; H04W 12/50; H04W 12/75; H04W 60/04; H04W 84/12

(52) U.S. Cl. CPC H04W 12/06; H04W 12/0431; H04W 12/50; H04W 12/75; H04W 60/04; H04W 84/12

(57) ABSTRACT

Embodiments include methods for a user equipment (UE) configured to communicate with a communications network via a first access network. Such methods include, without registering with the communications network. receiving from the communications network an authentication-related message that includes an identifier associated with the first access network and at least one of a temporary UE identifier and a security key identifier. Such methods include, based on the identifier, generating a first security key usable for establishing a secure connection with the first access network and establishing a secure connection with the first access network based on the first security key. Such methods include registering with the communications network based on the at least one of the temporary UE identifier and the security key identifier. Other embodiments include complementary methods for network nodes or functions (NNFs) of the communications network. as well as UEs and NNFs configured to perform such methods.

### TECHNICAL FIELD

The present disclosure relates generally to communication networks and more specifically to techniques for user equipment (UEs) to access wireless LANs (or other access networks) based on user credentials for a public land mobile network (PLMN, e.g., 5G network), and for subsequent registration of the UE with the PLMN based on the same user credentials.

### BACKGROUND

The fifth generation (5G) of cellular systems was initially standardized 3GPP Release 15(Rel-15) and continues to evolve in subsequent releases. NR is developed for maximum flexibility to support a variety of different use cases including enhanced mobile broadband (eMBB), machine type communications (MTC), ultra-reliable low latency communications (URLLC), side-link device-to-device (D2D), and several other use cases. 5G/NR technology shares many similarities with fourth-generation LTE.

At a high level, the 5G System (5GS) consists of an Access Network (AN) and a Core Network (CN). The AN provides UEs connectivity to the CN, e.g., via base stations such as gNBs or ng-eNBs. As described in more detail below, the CN includes a variety of Network Functions (NF) that provide a range of different functionalities such as session management, connection management, charging, authentication, etc.

FIG. 1 illustrates a high-level view of an exemplary 5G network architecture, which includes a Next Generation Radio Access Network (NG-RAN, 199) and a 5G Core (5GC, 198). The NG-RAN can include one or more gNodeB's (gNBs, e.g., 100, 150) connected to the 5GC via one or more NG interfaces (e.g., 102, 152). More specifically, the gNBs can be connected to one or more Access and Mobility Management Functions (AMFs) in the 5GC via respective NG-C interfaces and to one or more User Plane Functions (UPFs) in the 5GC via respective NG-U interfaces. Various other network functions (NFs) can be included in the 5GC, as described below.

In addition, the gNBs can be connected to each other via one or more Xn interfaces (e.g., 140 between gNBs 100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG RAN logical nodes shown in FIG. 1 include a Centralized Unit (CU or gNB-CU) and one or more Distributed Units (DU or gNB-DU). CUs (e.g., 110) are logical nodes that host higher-layer protocols and perform various gNB functions such controlling the operation of DUs. In contrast, DUs (e.g., 120, 130) are decentralized logical nodes that host lower layer protocols and can include, depending on the functional split option, various subsets of gNB functions. A CU connects to one or more DUs over respective F1 logical interfaces (e.g., 122, 132).

A change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

The 5G SBA model is based on principles including modularity, reusability, and self-containment of NFs, which can enable network deployments to take advantage of the latest virtualization and software technologies. In the 5G SBA, network repository functions (NRF) allow every network function to discover the services offered by other network functions, and Data Storage Functions (DSF) allow every network function to store its context.

3GPP has defined architectures to support UE accessing 5GC via trusted or untrusted non-3GPP access networks (e.g., WLAN). The architecture for trusted non-3GPP access to 5GC includes an interworking function (TWIF) that enables Non-5G-Capable over WLAN (N5CW) devices to access 5GC via trusted WLAN access networks. Additionally, 3GPP has defined an architecture that enables a UE to connect to a WLAN access network using its 5GS credentials without registration to 5GS. This architecture is based on the Non-Seamless WLAN Offload Function (NSWOF), which interfaces to the WLAN access network using the SWa interface as defined in 3GPP TS 23.402 (v17.0.0). NSWOF also interfaces to an authentication server function (AUSF) in 5GC via the Nausf Service Based Interface (SBI).

### SUMMARY

In the current 3GPP specifications, if the UE decides to access a WLAN by performing NSWO access and then decides to register to 5GC, authentication needs to be run twice, first for NSWO access and then for registering with 5GC via trusted/untrusted non-3GPP access. These two registrations may occur near in time, which requires excessive signaling and processing in both UE and 5GC.

An object of embodiments of the present disclosure is to improve registration of UEs via non-3GPP access, such as by facilitating solutions to overcome exemplary problems summarized above and described in more detail below.

Some embodiments include methods (e.g., procedures) for a UE configured to communicate with a communications network (e.g., 5GC) via at least a first access network.

These exemplary methods include, without registering with the communications network, receiving from the communications network an authentication-related message that includes an identifier associated with the first access network and at least one of a temporary UE identifier and a security key identifier. These exemplary methods also include, based on the identifier associated with the first access network, generating a first security key usable for establishing a secure connection with the first access network. These exemplary methods also include establishing a secure connection with the first access network based on the first security key and registering with the communications network based on the at least one of the temporary UE identifier and the security key identifier.

In some embodiments, the first security key is a master session key (MSK) or a non-seamless WLAN offload (NSWO) key, the communications network is a 5G network, the temporary UE identifier is a 5G globally unique temporary identifier (GUTI), the security key identifier is a non-access stratum (NAS) key set identifier (ngKSI), and the one or more second security keys include K_{AUSF}, K_{SEAF}, and K_{AMF}.

In some of these embodiments, the first access network is one of the following: a trusted wireless local area network (WLAN), a trusted non-3GPP access network, or a non-trusted non-3GPP access network. In some of these embodiments, registering with the communications network is based on K_{AMF}.

In some embodiments, registering with the communications network is via the secure connection with the first access network. In other embodiments, registering with the communications network is via a second access network different than the first access network.

Other embodiments include methods (e.g., procedures) for a first network node or function (NNF, e.g., NSWOF) of a communications network (e.g., 5GC).

These exemplary methods include receiving, from a UE via a first access network, a first authentication message that includes an identifier associated with user credentials for the communication network and. These exemplary methods include sending, to a second NNF of the communications network, an authentication request that includes the identifier associated with user credentials for the communications network. These exemplary methods include receiving the following from the second NNF: at least one of a temporary UE identifier and a security key identifier, an authentication response indicating that the UE is authenticated, and a first security key usable for establishing a secure connection between the UE and the first access network. These exemplary methods include forwarding the first security key to the first access network and the authentication response and forwarding the at least one of the temporary UE identifier and the security key identifier to the UE via the first access network.

In some embodiments, the authentication request also includes a second indication that the UE should be authenticated for accessing the first access network and for registration with the communications network, and the authentication response indicates that the UE is authenticated in accordance with the second indication.

In some embodiments, the first access network is one of the following: a trusted WLAN, a trusted non-3GPP access network, or a non-trusted non-3GPP access network. In some embodiments, the first security key is a master session key (MSK) or a non-seamless wireless LAN offload (NSWO) key.

In some embodiments, the communications network is a 5G network, the temporary UE identifier is a 5G GUTI, the security key identifier is a ngKSI, the first NNF is an NSWOF, and the second NNF is one of the following: an AMF separate from the NSWOF, an AMF combined with the NSWOF, or an AUSF.

Other embodiments include methods (e.g., procedures) for a second NNF (e.g., AMF) of a communications network (e.g., 5GC).

These exemplary methods can include receiving from a first NNF of the communications network, an authentication request for a UE. The authentication request includes an identifier associated with user credentials for the communication network. These exemplary methods can include allocating or selecting one or more of the following parameters for UE registration with the communications network: a temporary UE identifier, and a security key identifier. These exemplary methods can include sending the following information to the first NNF:
the allocated or selected one or more parameters,
an authentication response indicating that the UE is authenticated, and
a first security key usable for establishing a secure connection between the UE and the first access network.

In some embodiments, these exemplary methods can also include the following operations:
sending, to a third NNF of the communications network, a further authentication request for the UE, wherein the further authentication request includes the identifier associated with the user credentials; and
receiving the following from the third NNF: the authentication response, a second identifier associated with user credentials for the communication network, and an encrypted version of the allocated or selected one or more parameters.

In some embodiments, the authentication request also includes a second indication that the UE should be authenticated for accessing the first access network and for registration with the communications network, and the authentication response indicates that the UE is authenticated in accordance with the second indication.

In some embodiments, the communications network is a 5G network, the temporary UE identifier is a 5G GUTI, the security key identifier is a ngKSI, the first NNF is an NSWOF, the second NNF is an AMF, and the third NNF is an AUSF. In some of these embodiments, the first access network is one of the following: a trusted WLAN, a trusted non-3GPP access network, or a non-trusted non-3GPP access network.

In some embodiments, the authentication request and/or the further authentication request can explicitly or implicitly indicate that the UE should be authenticated for accessing a first access network and for registration with the communications network.

In some embodiments, the second NNF is combined with the first NNF. In other embodiments, or the second NNF is separate from the first NNF.

Other embodiments include methods (e.g., procedures) for a third NNF (e.g., AUSF) of a communications network (e.g., 5GC).

These exemplary methods can include receiving, from a first NNF or a second NNF of the communications network, an authentication request for a UE. The authentication request includes an identifier associated with user credentials for the communication network. These exemplary methods can include receiving, from the first NNF or the second NNF, at least one of a temporary UE identifier and a security key identifier. These exemplary methods can include sending the following information to a second NNF of the communications network:
an encrypted version of the at least one of the temporary UE identifier and the security key identifier,
an authentication response indicating that the UE is authenticated, and
a first security key usable for establishing a secure connection between the UE and the first access network.

In some embodiments, these exemplary methods can also include the following operations:
in response to the authentication request, sending a further authentication request for the UE to a fourth NNF of the communications network, wherein the further authentication request includes the identifier associated with the user credentials;
receiving, from the fourth NNF, a second identifier associated with the user credentials and an authentication vector usable to generate security keys for communication with the UE; and
deriving the following based on the authentication vector: a first security key usable for establishing a secure connection between the UE and the first access network, a security key (K_{SEAF}) associated with a security anchor function (SEAF) of the communications network, and a security key associated with the third NNF.

In some of these embodiments, the communications network is a 5G network, the temporary UE identifier is a 5G GUTI, the security key identifier is a ngKSI, the second NNF is an AMF, the third NNF is an AUSF, and the fourth NNF is a UDM function. In different variants, the first NNF can be an AMF or an NSWOF. In some variants, the first access network is one of the following: a trusted WLAN, a trusted non-3GPP access network, or a non-trusted non-3GPP access network.

In some embodiments, the authentication request and/or the further authentication request can explicitly or implicitly indicate that the UE should be authenticated for accessing a first access network and for registration with the communications network. In such embodiments, the authentication response can indicates that the UE is authenticated in accordance with the authentication request.

Other embodiments include UEs (e.g., wireless devices) and NNFs (e.g., NSWOFs, AMFs, and AUSFs) configured to perform operations corresponding to any of the exemplary methods described herein. Other embodiments include non-transitory, computer-readable media storing program instructions that, when executed by processing circuitry, configure such UEs and NNFs to perform operations corresponding to any of the exemplary methods described herein.

These and other embodiments described herein can provide various benefits and/or advantages. For example, since only one authentication procedure is needed for a UE, embodiments can reduce the signaling between UE and involved network entities, as well as processing load in UE and involved network entities, relative to conventional techniques that require two authentication procedures. Additionally, embodiments facilitate smaller delay when a UE registers to 5GC since the UE's NAS security context is already available from earlier access-related authentication. Also, embodiments maintain AMF as a main authentication anchor point in all cases including authentication for NSWO, non-3GPP access, and 3GPP access, which is very desirable.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIGS. 3-4 show exemplary non-roaming architectures for 5GC with untrusted and trusted non-3GPP access by UEs, respectively.

FIG. 5 shows an exemplary non-roaming architecture for N5CW device access via trusted WLAN.

FIG. 6 shows a 3GPP-defined architecture that enables a UE to connect to a WLAN using its 5GS credentials without registration to 5GS.

FIG. 7 shows a signaling diagram of an authentication procedure for untrusted, non-3GPP accesses to 5GC.

FIG. 8 (which includes FIGS. 8A-C) shows a signaling diagram of a procedure for authentication and PDU session establishment via trusted, non-3GPP accesses to 5GC.

FIG. 9 (which includes FIGS. 9A-B) shows a signaling diagram of an authentication procedure for N5CW devices that access 5GC via trust WLAN.

FIG. 10 shows a signaling diagram of an authentication procedure for Non-seamless WLAN offload (NSWO) in 5GC.

FIGS. 11-12 show exemplary non-roaming architectures for 5GC with untrusted and trusted non-3GPP access by UEs, respectively, according to some embodiments of the present disclosure.

FIG. 13 shows an exemplary non-roaming architecture for N5CW device access via trusted WLAN, according to other embodiments of the present disclosure.

FIGS. 14-16 show signaling diagrams for various authentication procedures for NSWO in 5GS, according to various embodiments of the present disclosure.

FIG. 17 shows an exemplary method (e.g., procedure) for a UE, according to various embodiments of the present disclosure.

FIG. 19 shows an exemplary method (e.g., procedure) for a first network node or function (NNF, e.g., NSWOF), according to various embodiments of the present disclosure.

FIG. 19 shows an exemplary method (e.g., procedure) for a second NNF (e.g., AMF), according to various embodiments of the present disclosure.

FIG. 20 shows an exemplary method (e.g., procedure) for a third NNF (e.g., AUSF), according to various embodiments of the present disclosure.

FIG. 21 shows a communication system according to various embodiments of the present disclosure.

FIG. 22 shows a UE according to various embodiments of the present disclosure. FIG. 23 shows a network node according to various embodiments of the present disclosure.

FIG. 24 shows host computing system according to various embodiments of the present disclosure.

FIG. 25 is a block diagram of a virtualization environment in which functions implemented by some embodiments of the present disclosure may be virtualized.

FIG. 26 illustrates communication between a host computing system, a network node, and a UE via multiple connections, at least one of which is wireless, according to various embodiments of the present disclosure.

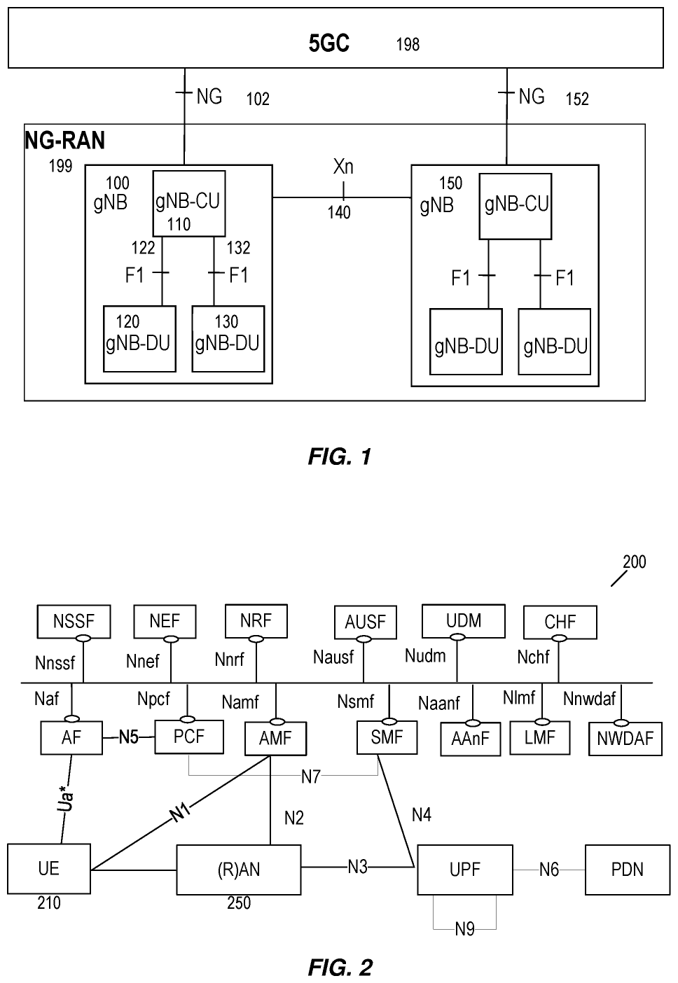

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In general, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is generally used. However, the concepts disclosed herein are not limited to a 3GPP system, and can be applied in any system that can benefit from the concepts, principles, and/or embodiments described herein.

FIG. 2 shows an exemplary non-roaming reference architecture for a 5G network (200) including the following 3GPP-defined NFs and service-based interfaces:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)—supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs. In general, NEF provides services similar to services provided by SCEF in EPC.
Network Repository Function (NRF) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Network Data Analytics Function (NWDAF) with Nnwdaf interface—provides network analytics information (e.g., statistical information of past events and/or predictive information) to other NFs on a network slice instance level.
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF. The terms “UDM” and “UDM function” are used interchangeably herein.

The NRF allows every NF to discover the services offered by other NFs, and Data Storage Functions (DSF) allow every NF to store its context. In addition, the NEF provides exposure of capabilities and events of the 5GC to AFs within and outside of the 5GC. For example, NEF provides a service that allows an AF to provision specific subscription data (e.g., expected UE behavior) for various UEs.

The services provided by the various NFs are composed of “service operations”, which are more granular divisions of the overall service functionality. The interactions between service consumers and producers can be of the type “request/response” or “subscribe/notify”. In the latter type, a service consumer NF (or equivalently, “consumer NF”) requests a service producer NF (or equivalently, “producer NF”) to establish a subscription for the service consumer NF to receive notifications from the service producer NF under conditions specified in this subscription.

Service Communication Proxy (SCP) is a 5GC NF that was introduced in Rel-16. SCP provides centralized capabilities such as service-based interface (SBI) routing, NF discovery and selection, failover, message screening, etc. More generally, SCP facilitates 5GC implementation in a highly distributed multi-access edge compute cloud environment. SCP provides a single point of entry for a cluster of NFs after they have been successfully discovered by the NRF. As such, the SCP becomes the delegated discovery point in a data center, offloading NRF from the distributed service meshes that can comprise a network operator's infrastructure.

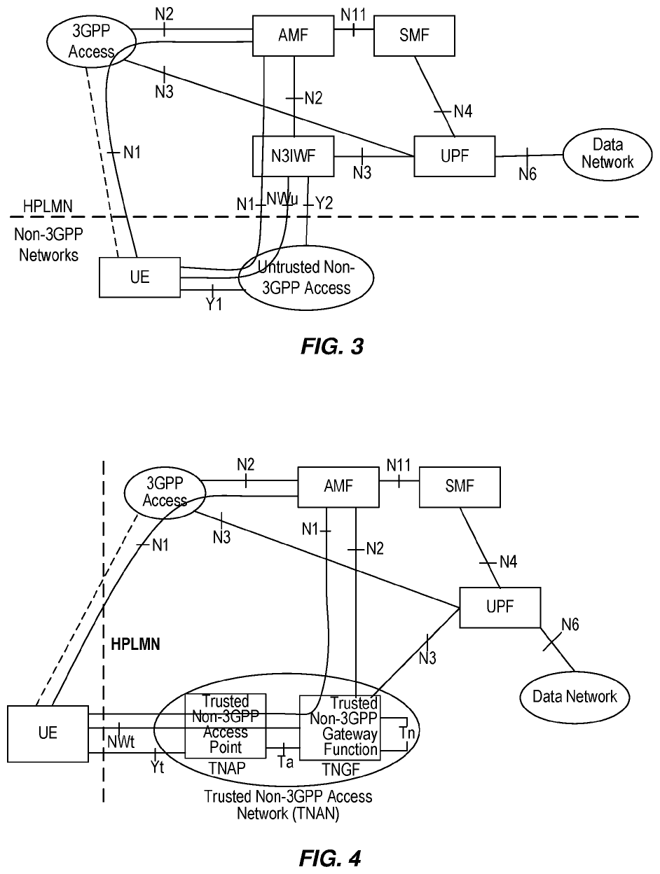

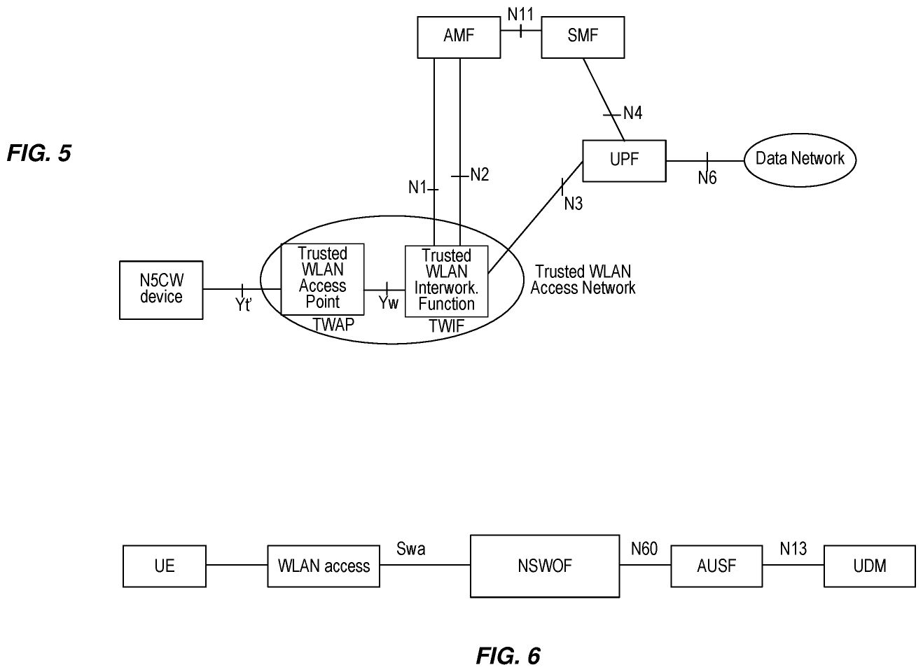

As briefly mentioned above, 3GPP has defined architectures to support UE accessing 5GC via trusted or untrusted non-3GPP access networks (e.g., WLAN). FIGS. 3 and 4 show exemplary non-roaming architectures for 5GC with untrusted and trusted non-3GPP access by UEs, respectively. 3GPP has also defined an interworking function (called TWIF) that enables Non-5G-Capable over WLAN (N5CW) devices to access 5GC via trusted WLAN access networks. FIG. 5 shows an exemplary non-roaming architecture for N5CW device access via trusted WLAN, which includes the TWIF mentioned above. Further details of the exemplary architectures shown in FIGS. 3-5 are given in 3GPP TS 23.501 (v17.4.0).

Additionally, FIG. 6 shows a 3GPP-defined architecture that enables a UE to connect to a WLAN using its 5GS credentials without registration to 5GS, which is further defined in 3GPP document S2-2203254. This architecture is based on the Non-Seamless WLAN Offload Function (NSWOF), which interfaces to the WLAN using the Sea interface as defined in 3GPP TS 23.402 (v17.0.0) and to an authentication server function (AUSF) in 5GC via the Nausf Service Based Interface (SBI). The functionality of NSWOF and the procedures applied for supporting WLAN connection using 5GS credentials for Non-seamless WLAN offload (NSWO) are further defined in 3GPP TS 33.501 (v17.5.0) Annex S. Note that 5G NWSO is not applicable to standalone non-public networks (SNPN).

The UE can also connect to a WLAN access network using 5GS credentials by performing the 5GS registration via trusted non-3GPP access procedure defined in 3GPP TS 23.502 (v17.5.0) section 4.12a.2.2. With this procedure, the UE connects to a WLAN access network using 5GS credentials and simultaneously registers in 5GS. However, the architecture shown in FIG. 6 enables a UE to connect to a WLAN access network using 5GS credentials but without registration in 5GS.

If the WLAN is configured as Untrusted Non-3GPP access but supports IEEE 802.1x, 5G NSWO may be used to access the WLAN. Any time after the UE obtains the connection to WLAN network and the local IP address, the UE may initiate Untrusted Non-3GPP Access to obtain the access to 5GC.

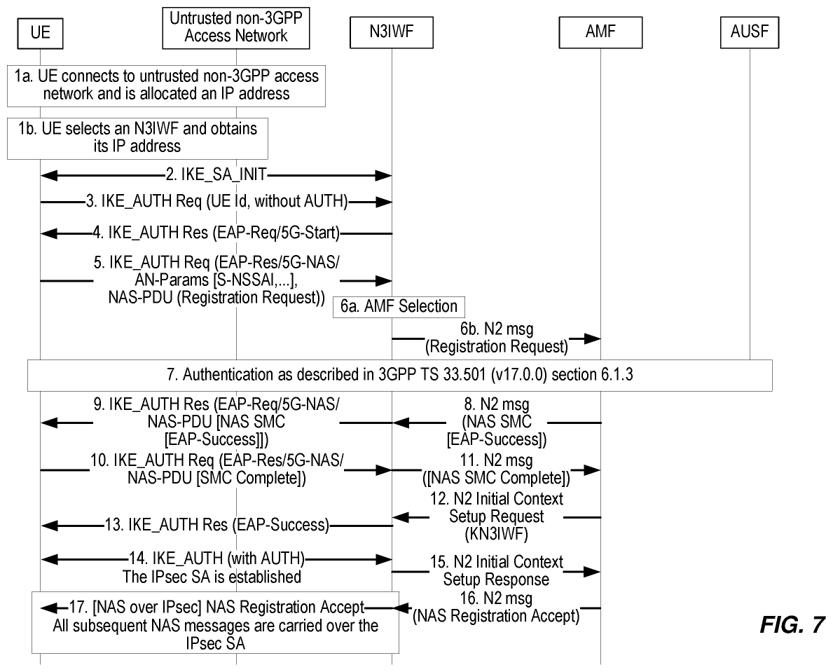

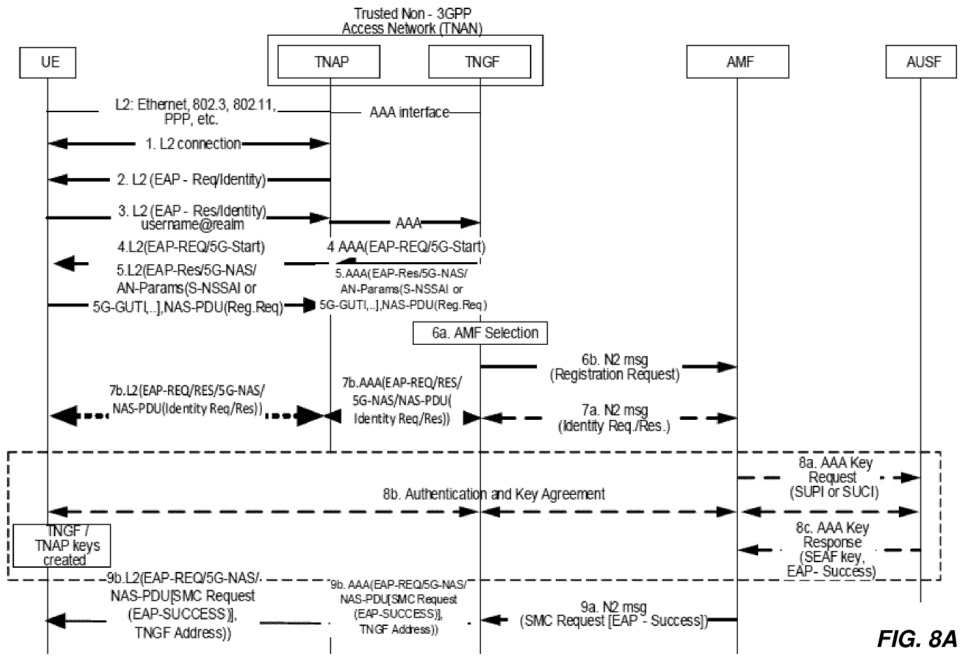

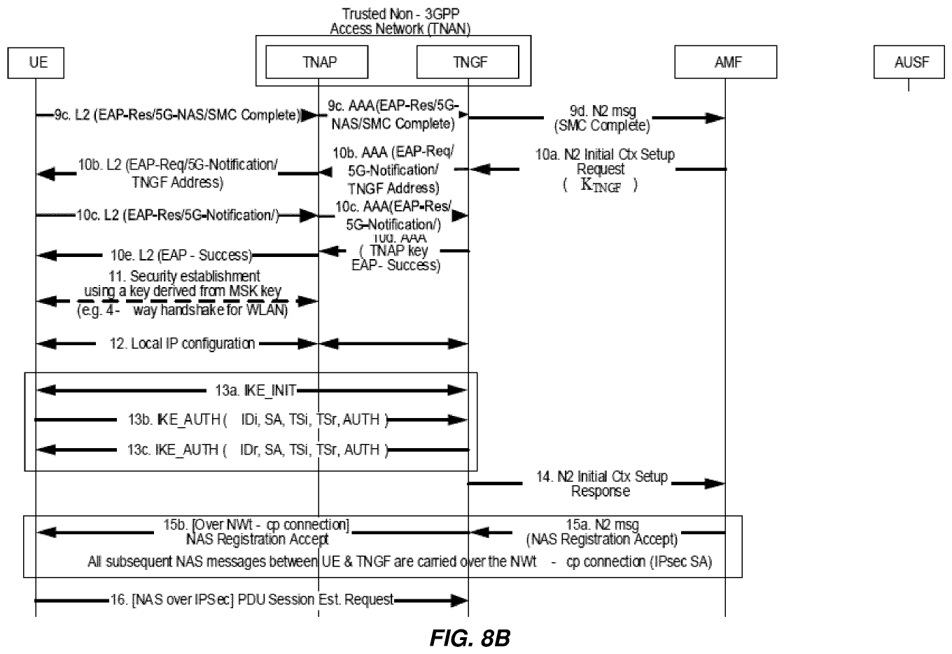

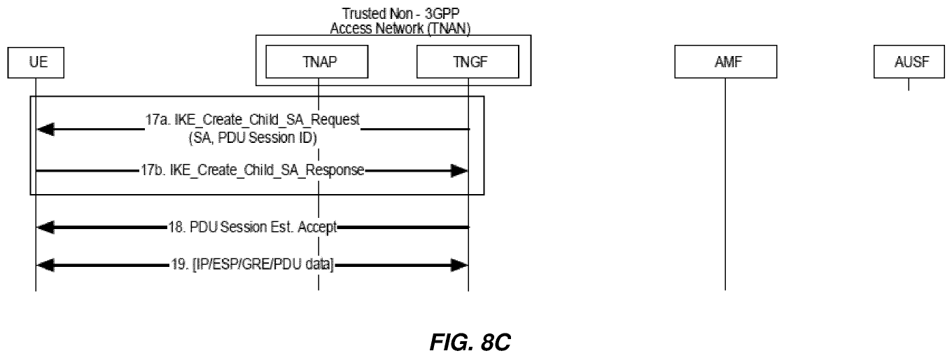

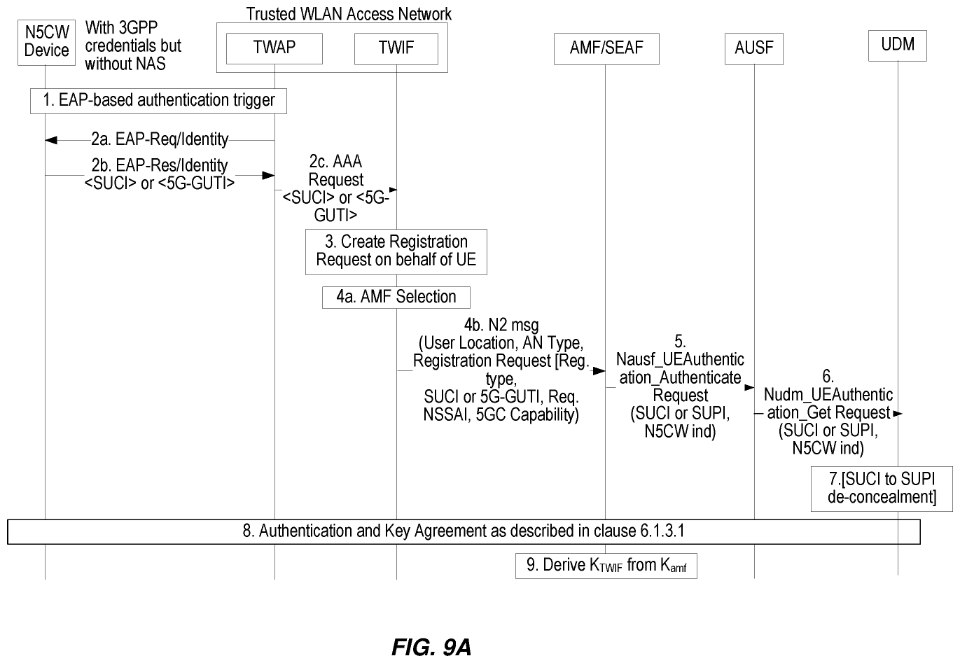

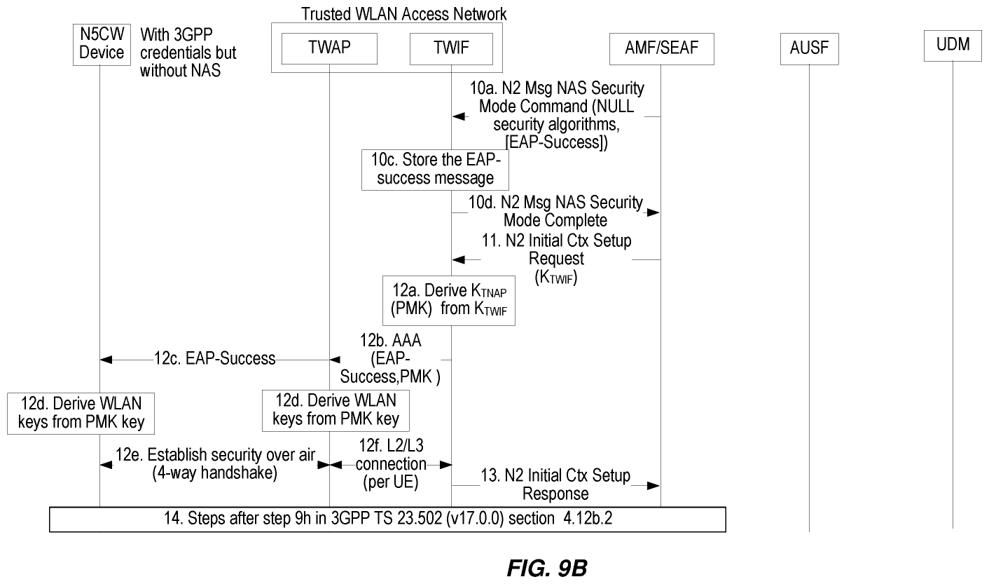

FIG. 7 shows a signaling diagram of an authentication procedure for untrusted, non-3GPP accesses to 5GC. FIG. 8 (which includes FIGS. 8A-C) shows a signaling diagram of a procedure for authentication and PDU session establishment via trusted, non-3GPP accesses to 5GC. Likewise, FIG. 9 (which includes FIGS. 9A-B) shows a signaling diagram of an authentication procedure for N5CW devices that access 5GC via trust WLAN. These procedures are further specified in 3GPP TS 33.501 (v17.5.0) sections 7.2.1, 7A.2.1, and 7A.2.4, respectively.

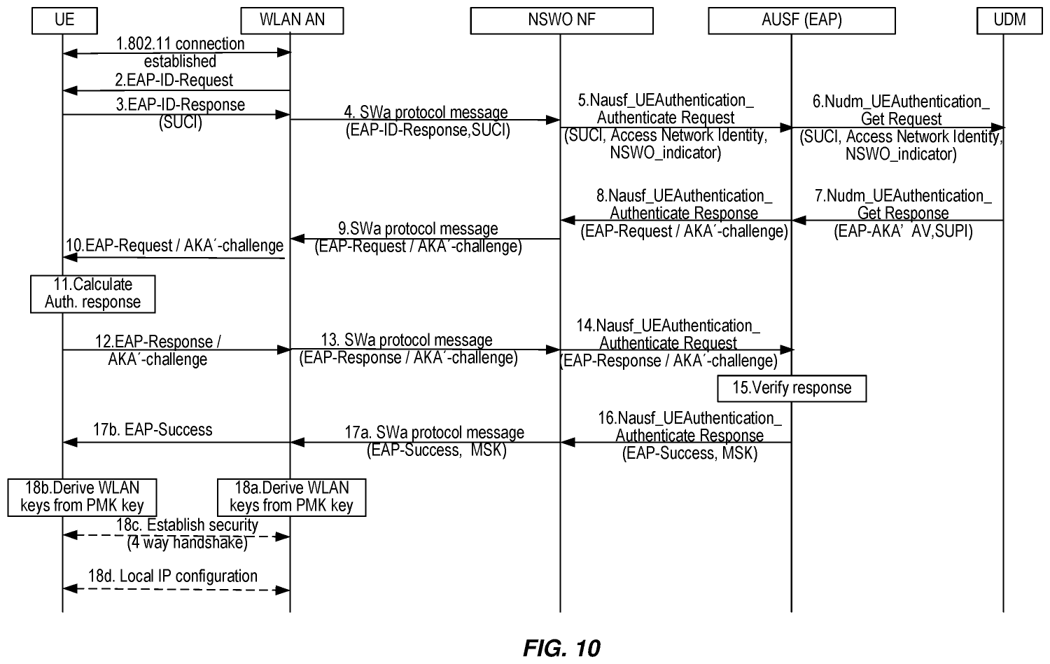

FIG. 10 shows a signaling diagram of an authentication procedure for Non-seamless WLAN offload (NSWO) in 5GC. This procedure is further specified in 3GPP TS 33.501 (v17.5.0) section S.3 (Annex S).

In the current 3GPP specifications, if the UE decides to access a WLAN by performing NSWO access and then decides to register to 5GC, authentication needs to be run twice, first for NSWO access and then for registering with 5GC via trusted/untrusted non-3GPP access. These two registrations may occur near in time, which requires excessive signaling and processing in both UE and 5GC.

Embodiments of the present disclosure address these and other problems, issues, and/or difficulties by novel, flexible, and efficient techniques whereby a UE can start registration to 5GC via 3GPP access or non-3GPP access using an existing NAS security context and does not have to run a new authentication. There are three main aspects of these techniques:
Key management: running authentication and key agreement involving both NSWOF and AMF so that NSWOF obtains a master session key (MSK) and AMF obtains anchor security key Kseaf.
Key identification: sending 5G global unique temporary identifier (GUTI) and NAS key set identifier (ngKSI) from AMF to AUSF, which then sends those protected to the UE.
Security algorithm negotiation: sending chosen NAS security algorithms from AMF to AUSF which sends those protected to the UE.

According to these techniques, when authentication and key agreement is performed for NSWO access, AMF also prepares keys and other parameters for NAS security. This allows the UE to later register to the 5GC without having to perform authentication again. For this to be possible, three security problems need to be solved: 1) Key management, 2) key identification, 3) security algorithm negotiation.

Certain embodiments related to key identification can be summarized as follows. For the UE to indicate the correct AMF and Kseaf/Kamf keys when sending a registration request, the UE and the AMF need to have the 5G-GUTI and ngKSI available. The AMF allocates 5G-GUTI (or other temporary UE identifier) and/or ngKSI (or other key identifier) and sends them to the AUSF during the authentication procedure, and the AUSF sends those to the UE encrypted and integrity protected in EAP-AKA′ signaling (e.g., in AT_ENCR_DATA attribute or another protected attribute).

Embodiments can provide various benefits and/or advantages. For example, since only one authentication procedure is needed for a UE, this can reduce the signaling between UE and involved network entities, as well as processing load in UE and involved network entities, relative to conventional techniques that require two authentication procedures. Additionally, embodiments facilitate smaller delay when a UE registers to 5GC since the UE's NAS security context is already available from earlier access-related authentication. Additionally, embodiments maintain AMF as the main authentication anchor point in all cases including authentication for NSWO, non-3GPP access, and 3GPP access, which is very desirable.

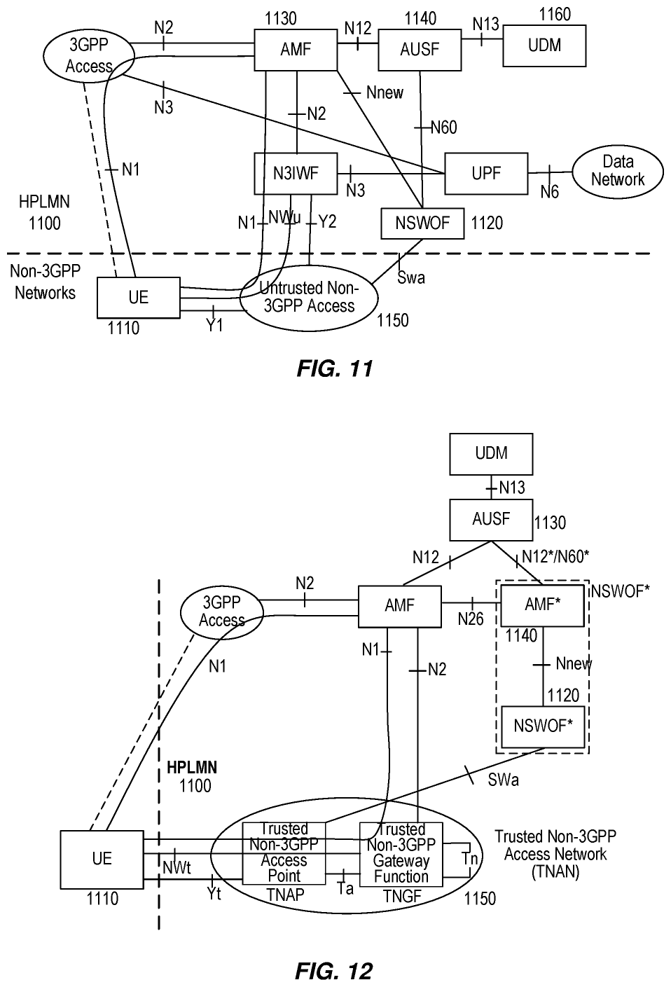

FIG. 11 shows an exemplary non-roaming architecture for 5GC with untrusted non-3GPP access by UEs, according to some embodiments of the present disclosure. The architecture shown in FIG. 11 is similar to the architecture shown in FIG. 3, except for the addition of AUSF (1140), UDM (1160), and NSWOF (1120) and their respective interfaces, including a new interface (“Nnew”) between AMF (1130) and NSWOF (1120). The UE (1110) accesses HPLMN (1100) via untrusted non-3GPP access network (1150, e.g., WLAN).

Likewise, FIG. 12 shows an exemplary non-roaming architecture for 5GC with trusted non-3GPP access by UEs, according to other embodiments of the present disclosure. The architecture shown in FIG. 12 is similar to the architecture shown in FIG. 4, except for the addition of AUSF (1140), UDM (1160), and NSWOF (1120) and their respective interfaces, including a new interface (“Nnew”) between AMF (1130) and NSWOF (1120). The UE (1110) accesses HPLMN (1100) via trusted non-3GPP access network (1150, e.g., WLAN).

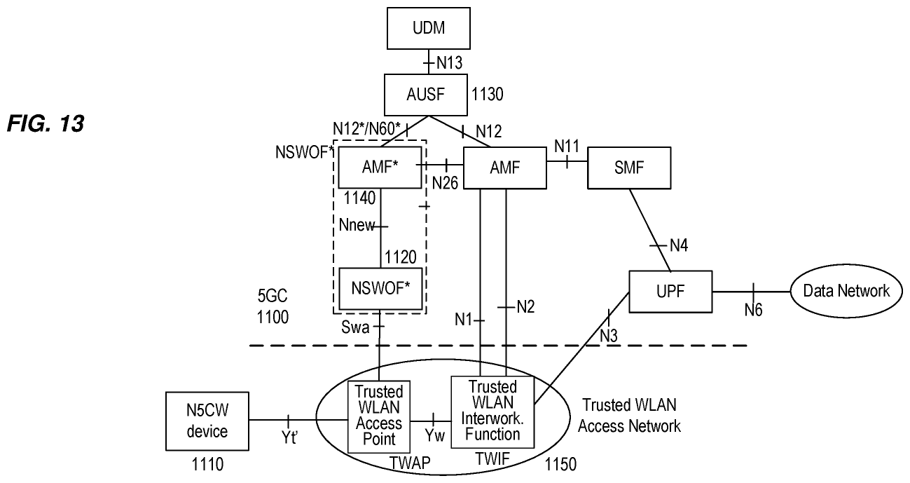

Similarly, FIG. 13 shows an exemplary non-roaming architecture for N5CW device access via trusted WLAN, according to other embodiments of the present disclosure. The architecture shown in FIG. 13 is similar to the architecture shown in FIG. 5, except for the addition of AUSF (1140), UDM (1160), and NSWOF (1120) and their respective interfaces, including a new interface (“Nnew”) between AMF (1130) and NSWOF (1120). The UE (1110) accesses 5GC (1100) via trusted WLAN (1150).

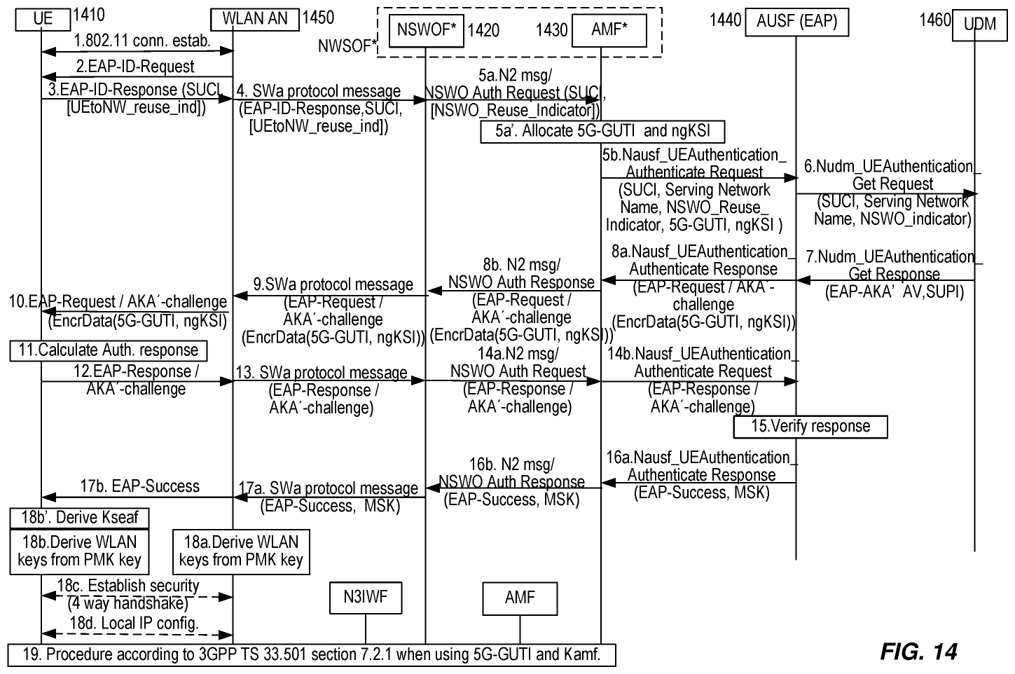

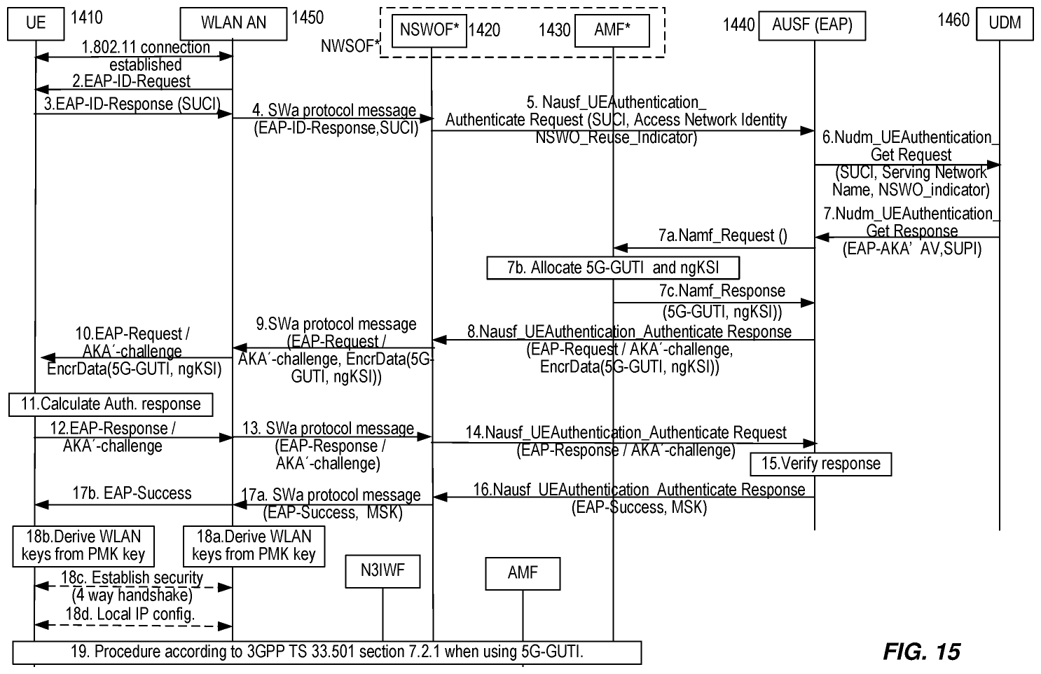

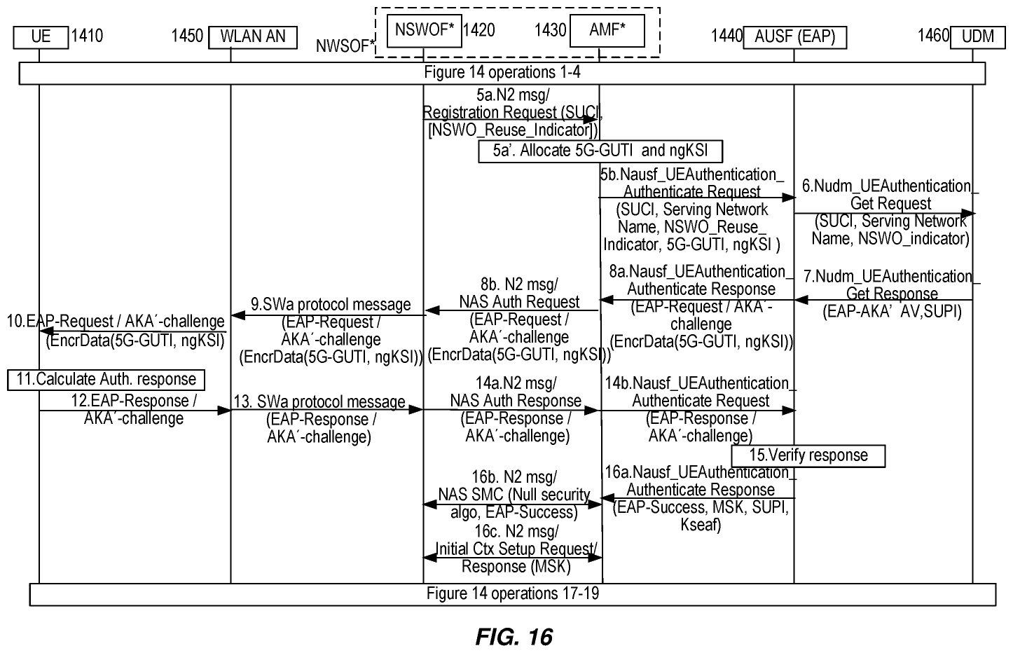

FIGS. 14-16 show signaling diagrams for various authentication procedures according to various embodiments of the present disclosure. The procedures shown in these figures involve a UE (1410), a WLAN access network (AN, 1450), an NSWOF (1420), an AMF (1430), an AUSF (1440), and a UDM (1460). These figures are described in more detail below.

Some embodiments involving key identification during enhanced NSWO authentication and key agreement procedures will now be described in the context of the authentication procedure for NSWO in 5GS specified in 3GPP TS 33.501 (v17.5.0) Annex S.

FIG. 14 shows a signaling diagram for an authentication procedure for NSWO in 5GS, according to some embodiments of the present disclosure. Although the operations shown in FIG. 14 are given numerical labels, this is intended to facilitate explanation rather than to require or imply any sequential order, unless express stated or unambiguously implied by a particular context.

In operation 1, the UE establishes a connection with the WLAN AN, using procedures specified in IEEE 802.11. In operation 2, the WLAN AN sends an EAP Identity/Request to the UE. In operation 3, the UE responds with an EAP Response/Identity message. The UE uses the subscription concealed identifier (SUCI) in NAI format (i.e., username@realm format as specified in 3GPP TS 23.003 section 28.7.3]) as its identity irrespective of whether SUPI Type configured on the UE's USIM is IMSI or NAI. If the SUPI Type configured on the USIM is IMSI, the UE constructs the SUCI in NAI format with username containing the encrypted MSIN and the realm part containing the MCC/MNC. In operation 4, the EAP Response/Identity message is routed over SWa interface towards NSWOF based on the realm part of the SUCI. NSWOF acts as SBI/AAA proxy between the AUSF and the WLAN Access Network.

Both UE and network need to know when the enhanced authentication is to be run. In some embodiments, the enhanced authentication is performed by default. In other embodiments, the UE decides when the enhanced authentication is to be run. In such embodiments, the UE sends an indication (UEtoNW_reuse_indicator) to NSWOF via WLAN in operations 3-4. This indicates to the NSWOF that combined NSWO authentication and primary authentication is to be run.

In operation 5a, NSWOF determines, based on local policy (i.e., default) or an indication received from the UE in operation 4, that enhanced authentication is to be performed. NSWOF selects an AMF and sends an N2 message to the selected AMF including NSWO Auth Request message, containing SUCI, Access Network Identity and NSWO_Reuse_Indicator. In some variants, a specific NSWO N2 message is proposed. In other variants, an existing N2 messages can be reused and/or repurposed. In the message of operation 5a, NSWO reuse indicator can be used to indicate to AMF that the authentication request is for both NSWO and primary authentication. Alternately, the authentication request from NSWOF to AMF implicitly indicates that the authentication is for both NWSO and primary authentication (e.g., if this is a new message or service type).

In operation 5a′, AMF allocates a 5G-GUTI and ngKSI to the UE based on the information received in operation 5a. In operation 5b, AMF sends the message Nausf UEAuthentication_Authenticate Request with SUCI, Access Network Identity, and NSWO_Reuse_Indicator towards AUSF. AMF also includes the 5G-GUTI and ngKSI allocated in operation 5a′. In the message of operation 5b, NSWO_reuse_indicator can be used to indicate to AMF that the authentication request is for both NSWO and primary authentication. Alternately, the authentication request from AMF to AUSF implicitly indicates that the authentication is for both NWSO and primary authentication (e.g., if this is a new message or service type).

In operation 6, AUSF checks whether AMF is entitled to use the SNN value “5G:NSWO:PLMNID”. AUSF (acting as the EAP authentication server) sends a Nudm UEAuthentication_Get Request to the UDM, including SUCI, the Serving Network Name, and an NSWO_indicator (e.g., indicating that authentication is for NSWO). After receiving the Nudm_UEAuthentication_Get Request, the UDM invokes SIDF to de-conceal SUCI to obtain the corresponding subscription permanent identifier (SUPI), which it sends to UDM. Based on the NSWO_indicator, UDM selects the EAP-AKA′ authentication method and generates an authentication vector using the Access Network Identity as the KDF input parameter. In the Nudm_UEAuthentication_Get Response message of operation 7, UDM includes the EAP-AKA′ authentication vector (RAND, AUTN, XRES, CK′ and IK′) and may include SUPI.

In operation 8a, AUSF stores XRES for future verification and sends the EAP-Request/AKA′-Challenge message to AMF in a Nausf_UEAuthentication_Authenticate Response message, which includes 5G-GUTI and ngKSI received from AMF protected in an AT_ENCR_DATA parameter. In operation 8b, AMF sends the EAP-Request/AKA′-Challenge message with the protected parameters to the NSWOF. In operation 9, NSWOF sends the EAP-Request/AKA′-Challenge message with the protected parameters to the WLAN AN via the SWa interface. In operation 10, the WLAN AN forwards the EAP-Request/AKA′-Challenge message with the protected parameters to the UE.

In some embodiments, the network decides when the enhanced authentication is to be run. In some of these embodiments, AUSF includes an indication NWtoUE_reuse_indicator of enhanced authentication together with 5G-GUTI and ngKSI in the protected AT_ENCR DATA field of the EAP-AKA′ sent in operation 8a, which can be forwarded to the UE in operations 8b-10. In other of these embodiments, AMF or NSWOF can provide this indication in the messages sent to the UE in operations 8b or 9, respectively.

In operation 11, upon receipt of the RAND and AUTN in the EAP-Request/AKA′-Challenge message, the UE's mobile equipment (ME) obtains the Access Network Identity from the EAP signaling and the UE's USIM verifies the freshness of the AV′ by checking whether AUTN can be accepted. If so, the USIM computes a response RES and return it with CK, IK to the ME. The ME then derive CK′ and IK′ using the Access Network Identity as the key derivation function (KDF) input parameter. If the verification of the AUTN fails on the USIM, then the USIM and ME shall proceed as described in 3GPP TS 33.501 section 6.1.3.3. The UE may derive MSK from CK′ and IK′ as per 3GPP TS 33.501 Annex F and as described in IETF RFC 5448. The UE also generates key K_{AUSF}.

In operation 12, the UE sends the EAP-Response/AKA′-Challenge message to the WLAN AN, which forwards it over the SWa interface to NSWOF in operation 13. In operation 14a, NSWOF sends the AMF an NSWO Auth Request message with EAP-Response/AKA′-Challenge using N2 message for transport. In operation 14b, the AMF sends an Nausf_UEAuthentication_Authenticate Request with EAP-Response/AKA′-Challenge message to AUSF.

In operation 15, AUSF verifies that the received response RES matches the stored and expected response XRES. If successfully verified, AUSF continues to operation 16; otherwise it returns an error to AMF. The AUSF derives the required MSK and K_{AUSF} from CK′ and IK′ as per 3GPP TS 33.501 Annex F and as described in IETF RFC 5448, based on the NSWO reuse indicator received in operation 5. AUSF also generates the keys K_{AUSF} and K_{SEAF}.

In operation 16a, AUSF sends AMF an Nausf_UEAuthentication_Authenticate Response message with EAP-Success, MSK, SUPI, and K_{SEAF}. In operation 16b, the security anchor function (SEAF) of AMF generates Kamf from Kseaf. AMF sends an NSWO Auth Response message with EAP-Success and MSK to NSWOF via N2 message, and keeps the received SUPI and Kamf.

In operation 17, NSWOF sends EAP-success and MSK to the WLAN AN over the SWa interface. The EAP-Success message is forwarded from WLAN AN to the UE. In operation 18, upon receiving the EAP-Success message, the UE derives the MSK as specified in operation 11, if it did not derived the MSK earlier. The UE also derives K_{SEAF} and Kamf. and uses MSK to perform 4-way handshake to establish a secure connection with the WLAN AN.

In operation 19, after the above-described procedure is complete, the UE can start a procedure for accessing 5GC via untrusted or trusted non-3GPP access or even via 3GPP access without having to run a new authentication. This is possible since both the UE and AMF have keys available to be able to authenticate and start NAS security.

In some variants, NSWOF also takes on AMF's role, performing tasks shown as being performed by AMF in FIG. 14. This option is shown in FIG. 14 by the dashed box around NSWOF and AMF.

FIG. 15 shows a signaling diagram for an authentication procedure for NSWO in 5GS, according to other embodiments of the present disclosure. Although the operations shown in FIG. 15 are given numerical labels, this is intended to facilitate explanation rather than to require or imply any sequential order, unless express stated or unambiguously implied by a particular context.

Operations 1-4 are substantially similar to FIG. 14 operations 1-4. In FIG. 15, NSWOF determines whether enhanced authentication should be performed and indicates this by including NSWO_Reuse_Indicator in the Nausf_UEAuthentication_Authenticate Request message sent to AUSF in operation 5. The NSWOF also includes the SUCI, the Access Network Identity, and optionally an address associated with AMF (not shown). Operations 6-7 are substantially similar to FIG. 14 operations 6-7.

In operations 7a-b, AMF allocates 5G-GUTI and ngKSI upon request from AUSF and provides this information to AUSF in operation 7c. In operation 8, AUSF responds to NSWOF with an Nausf_UEAuthentication_Authenticate Response message that include the EAP-Request/AKA′-Challenge. AUSF also includes 5G-GUTI and ngKSI received from AMF, protected in an AT_ENCR_DATA parameter. In operation 9, NSWOF sends the EAP-Request/AKA′-Challenge message and the protected parameters to the WLAN AN via the SWa interface. In operation 10, the WLAN AN forwards the EAP-Request/AKA′-Challenge message and the protected parameters to the UE.

Operations 11-13 are substantially similar to FIG. 14 operations 11-13. In operation 14, NSWOF sends AUSF an Nausf_UEAuthentication_Authenticate Request message with EAP-Response/AKA′-Challenge using N2 message for transport. In operation 15, AUSF verifies that the received response RES matches the stored and expected response XRES. If successfully verified, AUSF continues to operation 16; otherwise it returns an error to NSWOF. The AUSF derives the required MSK and K_{AUSF} from CK′ and IK′ as per 3GPP TS 33.501 Annex F and as described in IETF RFC 5448, based on the NSWO reuse indicator received in operation 5. AUSF also generates the keys K_{AUSF} and K_{SEAF}.

In operation 16, AUSF sends NSWOF an Nausf_UEAuthentication_Authenticate Response message with EAP-Success and MSK. Operations 17-19 are substantially similar to FIG. 14 operations 17-19, except that the UE does not derive Kseaf as done in FIG. 14 operation 18b′. Although not shown, in some variants AUSF sends AMF a message that includes the UE's SUPI and Kseaf derived by the SEAF of AUSF. Alternatively, AUSF may include SUPI and Kseaf in the Nausf_UEAuthentication_Authenticate Response message to NSWOF, which may forward them to AMF.

In some variants, NSWOF also takes on AMF's role, performing tasks shown as being performed by AMF in FIG. 15. This option is shown in FIG. 15 by the dashed box around NSWOF and AMF.

In some of these embodiments, AUSF can includes an indication NWtoUE_reuse_indicator of enhanced authentication together with 5G-GUTI and ngKSI in the protected AT_ENCR_DATA field of the EAP-AKA′ sent in operation 8, which can be forwarded to the UE in operations 9-10. In other of these embodiments, NSWOF can provide this indication in the message sent to the UE in operation 9.

Other embodiments based on modifications of the signaling shown in FIG. 15 are possible. For example, in some embodiments, NSWOF instead of AUSF fetches 5G-GUTI and ngKSI from AMF and sends them to AUSF, which then sends them to the UE in EAP-AKA′. After a successful authentication, AUSF sends Kseaf (and SUPI) to AMF. Alternatively, AUSF sends Kseaf to NSWOF, which sends it to AMF. AMF also sends SNN to NSWOF.

Other embodiments can be employed to re-use existing messages to have less impact on existing nodes in 5GC. Instead of introducing new N2 messages specific to procedure between NSWOF and AMF (e.g., NSWO auth request/response messages), NSWOF and AMF can perform a registration procedure reusing mostly existing signaling/messages for that procedure. NSWOF exchanges NAS messages with AMF on behalf of the NSWO device and terminates NAS protocol stack, e.g., with NULL NAS SMC. In that manner, impact to existing N1/N2 interface handling in AMF is reduced.

FIG. 16 shows a signaling diagram for an authentication procedure for NSWO in 5GS, according to some embodiments of the present disclosure. Although the operations shown in FIG. 16 are given numerical labels, this is intended to facilitate explanation rather than to require or imply any sequential order, unless express stated or unambiguously implied by a particular context.

The procedure shown in FIG. 16 is substantially similar to the procedure shown in FIG. 14, except for the names of the messages in operations 5a, 8b, and 14a. Additionally, FIG. 14 operation 16b is replaced by two message exchanges: a NAS SMC Request/Response in operation 16b, and an Initial Context Setup Request/Response in operation 16c.

Variants similar to ones discussed above in relation to FIGS. 14-15 can also be applied to the procedure shown in FIG. 16. For example, in some variants, NSWOF also takes on AMF's role, performing tasks shown as being performed by AMF in FIG. 16. This option is shown in FIG. 16 by the dashed box around NSWOF and AMF.

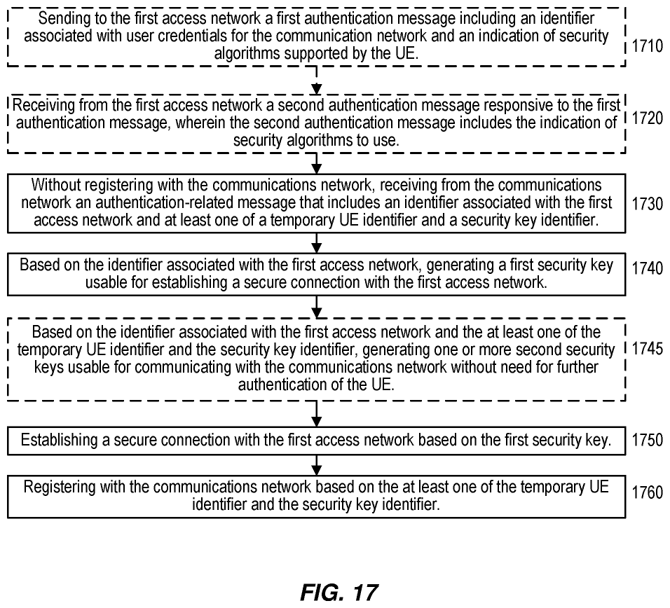

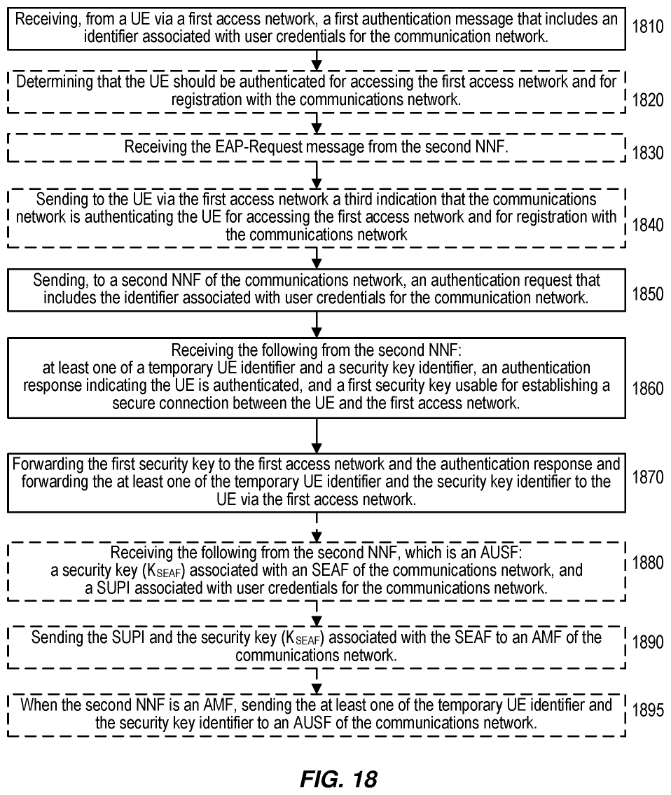

The embodiments described above are further illustrated by FIGS. 17-20, which depict exemplary methods (e.g., procedures) for a UE, a first network node or function (NNF), a second NNF, and a third NNF, respectively. Put differently, various features of the operations described below correspond to various embodiments described above, including the embodiments shown in FIGS. 14-16. The exemplary methods shown in FIGS. 17-20 can be used cooperatively (e.g., with each other and with other procedures described herein) to provide benefits, advantages, and/or solutions to problems described herein. Although the exemplary methods are illustrated in FIGS. 17-20 by specific blocks in particular orders, the operations corresponding to the blocks can be performed in different orders than shown and can be combined and/or divided into blocks and/or operations having different functionality than shown. Optional blocks and/or operations are indicated by dashed lines.

In particular, FIG. 17 illustrates an exemplary method (e.g., procedure) for a UE configured to communicate with a communications network (e.g., 5GC) via at least a first access network, according to various embodiments of the present disclosure. For example, the exemplary method shown in FIG. 17 can be performed by a UE (e.g., wireless device) such as described elsewhere herein.

The exemplary method can include the operations of block 1730, where without registering with the communications network, the UE can receive from the communications network an identifier associated with the first access network and at least one of a temporary UE identifier and a security key identifier. The exemplary method can also include the operations of block 1740, where based on the identifier associated with the first access network, the UE can generate a first security key usable for establishing a secure connection with the first access network. The exemplary method can also include the operations of blocks 1750-1760, where the UE can establish a secure connection with the first access network based on the first security key and register with the communications network based on the at least one of the temporary UE identifier and the security key identifier.

In some embodiments, the exemplary method can also include the operations of block 1745, where based on the identifier associated with the first access network and the at least one of the temporary UE identifier and the security key identifier, the UE can generate one or more second security keys usable for communicating with the communications network without need for further authentication of the UE.

In some of these embodiments, the first security key is a master session key (MSK) or a non-seamless WLAN offload (NSWO) key, the communications network is a 5G network, the temporary UE identifier is a 5G-GUTI, the security key identifier is a NAS key set identifier (ngKSI), and the one or more second security keys include K_{AUSF}, K_{SEAF}, and K_{AMF}. In some of these embodiments, registering with the communications network in block 1760 is based on K_{AMF}. In some of these embodiments, the first access network is one of the following: a trusted WLAN, a trusted non-3GPP access network, or a non-trusted non-3GPP access network.

In some embodiments, the authentication-related message is an EAP-Request message or an EAP-Success message.

In some embodiments, the exemplary method can also include the operations of blocks 1710-1720, where the UE can send to the first access network a first authentication message including an identifier associated with user credentials for the communication network and an indication of security algorithms supported by the UE, and receive from the first access network a second authentication message responsive to the first authentication message. In particular, the second authentication message includes the indication of security algorithms to use.

In some of these embodiments, the first authentication message includes an indication that the UE is requesting authentication for accessing the first access network and for registration with the communications network. In other of these embodiments, the second authentication message includes an indication that the communications network is authenticating the UE for accessing the first access network and for registration with the communications network.

In some of these embodiments, the first authentication message is an EAP Response/Identity message and the second authentication message is an EAP-Request message. In some of these embodiments, the identifier associated with user credentials for the communications network is a SUCI.

In some embodiments, the at least one of the temporary UE identifier and the security key identifier is included in a data parameter of the authentication-related message, with the data parameter being encrypted and/or integrity protected. In some embodiments, the identifier associated with the first access network is included in one of the following fields of the authentication-related message: access network identity, or serving network name.

In some embodiments, registering with the communications network in block 1760 is via one of the following: the secure connection with the first access network, or a second access network different than the first access network.

In addition, FIG. 18 illustrates an exemplary method (e.g., procedure) for a first NNF of a communications network (e.g., 5GC), according to various embodiments of the present disclosure. For example, the exemplary method shown in FIG. 18 can be performed by an NSWOF (or a network node hosting the same) such as described elsewhere herein.

The exemplary method can include the operations of block 1810, where the first NNF can receive, from a UE via a first access network, a first authentication message that includes an identifier associated with user credentials for the communication network. The exemplary method can include the operations of block 1850, where the first NNF can send, to a second NNF of the communications network, an authentication request that includes the identifier associated with user credentials for the communication network. The exemplary method can include the operations of block 1860, where the first NNF can receive the following from the second NNF: an indication of security algorithms for the UE to use when communicating with the communications network, an authentication response indicating that the UE is authenticated, and a first security key usable for establishing a secure connection between the UE and the first access network. The exemplary method can include the operations of block 1870, where the first NNF can forward the first security key to the first access network and forward the at least one of the temporary UE identifier and the security key identifier to the UE via the first access network.

In some embodiments, the first access network is one of the following: a trusted wireless local area network (WLAN), a trusted non-3GPP access network, or a non-trusted non-3GPP access network. In some embodiments, the first security key is one of the following: a master session key (MSK), or a non-seamless wireless LAN (WLAN) offload (NSWO) key.

In some embodiments, the first authentication message is an EAP Response/Identity message and the authentication response is an EAP-Success message. In some embodiments, the at least one of the temporary UE identifier and the security key identifier is received (e.g., in block 1860) and forwarded (e.g., in block 1870) in a data parameter of an EAP-Request message, with the data parameter being encrypted and/or integrity protected.

In some embodiments, the authentication request also includes a second indication that the UE should be authenticated for accessing the first access network and for registration with the communications network, and the authentication response indicates that the UE is authenticated in accordance with the second indication.

In some of these embodiments, the second indication is included in the authentication request (e.g., in block 1850) based on the first NNF determining in block 1820 that the UE should be authenticated for accessing the first access network and for registration with the communications network. In some variants of these embodiments, determining that the UE should be authenticated for accessing the first access network and for registration with the communications network is based on one of the following:
an indication that the UE is requesting authentication for accessing the first access network and for registration with the communications network, included in the first authentication message; or
local policy of the first NNF that each UE authentication should be for accessing the first access network and for registration with the communications network.

In some further variants, when the determination in block 1820 is based on local policy, the exemplary method can also include the operations of block 1840, where the first NNF can send to the UE via the first access network a third indication that the communications network is authenticating the UE for accessing the first access network and for registration with the communications network.

For example, the third indication can be sent to the UE in a data parameter of an EAP-Request message, with the data parameter being encrypted and/or integrity protected. In some variants of this example, the exemplary method can also include the operations of block 1830, where the first NNF can receive the EAP-Request message from the second NNF; in such case the received EAP-Request message is forwarded to the UE via the first access network (e.g., in block 1840).

In other of these embodiments, the authentication request sent to the second NNF in block 1840 implicitly indicates that the UE should be authenticated for accessing the first access network and for registration with the communications network.

In some embodiments, the communications network is a 5G network, the temporary UE identifier is a 5G GUTI, the security key identifier is a ngKSI, the first NNF is an NSWOF, and the second NNF is one of the following: an AMF separate from the NSWOF, an AMF combined with the NSWOF, or an AUSF. FIG. 14 shows an example of embodiments where the second NNF is an AMF, while FIG. 15 shows an example of embodiments where the second NNF is an AUSF. In some of these embodiments, the authentication request also includes an address of an AMF that supports registration of the UE with the communications network. In some of these embodiments, the identifier associated with user credentials for the communication network is a SUCI.

In some of these embodiments, the exemplary method can also include the following operations, labelled with corresponding block numbers:
(1880) receiving the following from the second NNF, which is an AUSF: a security key (K_{SEAF}) associated with a security anchor function (SEAF) of the communications network, and a subscription public identifier (SUPI) associated with user credentials for the communications network; and
(1890) sending the SUPI and the security key (K_{SEAF}) associated with the SEAF to an AMF of the communications network.

In other of these embodiments, when the second NNF is an AMF, the exemplary method can also include the operations of block 1895, where the first NNF (e.g., NSWOF) can send the at least one of the temporary UE identifier and the security key identifier to an AUSF of the communications network.

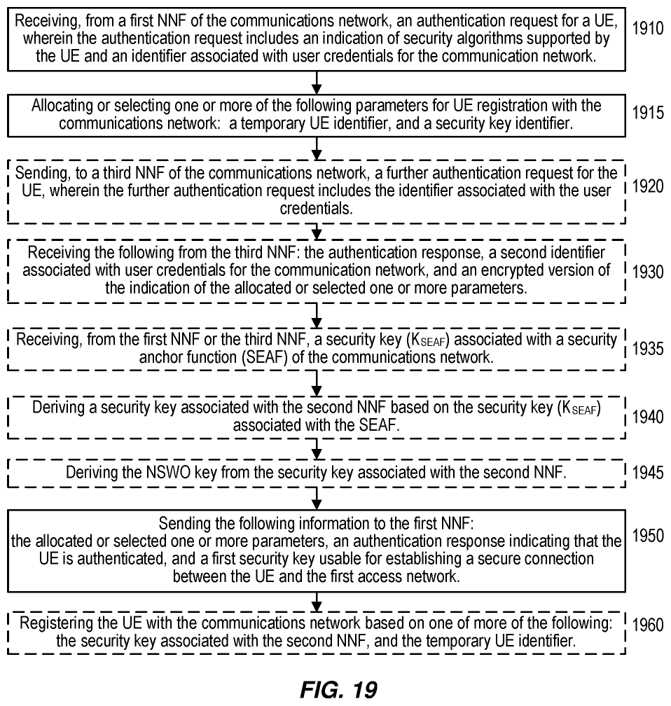

In addition, FIG. 19 illustrates an exemplary method (e.g., procedure) for a second NNF of a communications network (e.g., 5GC), according to various embodiments of the present disclosure. For example, the exemplary method shown in FIG. 19 can be performed by an AMF (or a network node hosting the same or similar functionality) such as described elsewhere herein.

The exemplary method can include the operations of block 1910, where the second NNF can receive, from a first NNF of the communications network, an authentication request for a UE. The authentication request includes an identifier associated with user credentials for the communication network. The exemplary method can include the operations of block 1915, where the second NNF can allocate or select one or more of the following parameters for UE registration with the communications network: a temporary UE identifier, and a security key identifier. The exemplary method can include the operations of block 1950, where the second NNF can send the following information to the first NNF:
the allocated or selected one or more parameters,
an authentication response indicating that the UE is authenticated, and
a first security key usable for establishing a secure connection between the UE and the first access network.

In some embodiments, the exemplary method can also include the following operations, labelled with corresponding block numbers:
(1920) sending, to a third NNF of the communications network, a further authentication request for the UE, wherein the further authentication request includes the identifier associated with the user credentials; and
(1930) receiving the following from the third NNF: the authentication response, a second identifier associated with user credentials for the communication network, and an encrypted version of the allocated or selected one or more parameters.

In some of these embodiments, the further authentication request also includes the allocated or selected one or more parameters. In some of these embodiments, the encrypted version of the indication of the allocated or selected one or more parameters is received from the third NNF (e.g., in block 1930) in a data parameter of an EAP-Request message. The data parameter is encrypted and/or integrity protected, and the EAP-request message is forwarded to the first NNF.

In some of these embodiments, the exemplary method can also include the following operations, labelled with corresponding block numbers:
(1935) receiving, from the first NNF or the third NNF, a security key (K_{SEAF}) associated with a security anchor function (SEAF) of the communications network; and
(1940) deriving a security key associated with the second NNF based on the security key (K_{SEAF}) associated with the SEAF.

In some variants of these embodiments, the exemplary method can also include the operations of block 1960, where the second NNF can subsequently (e.g., after block 1950) register the UE with the communications network based on one of more of the following: the security key associated with the second NNF, and the temporary UE identifier.

In some of these embodiments, the first security key is a master session key (MSK), which is also received from the third NNF. In other of these embodiments, wherein the first security key is an NSWO key and the exemplary method also includes the operations of block 1945, where the second NNF can derive the NSWO key from the security key associated with the second NNF.

In some of these embodiments, the communications network is a 5G network, the temporary UE identifier is a 5G GUTI, the security key identifier is a ngKSI, the first NNF is an NSWOF, the second NNF is an AMF, and the third NNF is an AUSF. In some of these embodiments, the first access network is one of the following: a trusted WLAN, a trusted non-3GPP access network, or a non-trusted non-3GPP access network. In some of these embodiments, the identifier associated with user credentials is a SUCI and the second identifier associated with user credentials is a SUPI.

In some of these embodiments, the authentication request in block 1910 also includes a second indication that the UE should be authenticated for accessing the first access network and for registration with the communications network, and the authentication response indicates that the UE is authenticated in accordance with the second indication. In other of these embodiments, the authentication request implicitly indicates that the UE should be authenticated for accessing the first access network and for registration with the communications network.

In some variants of these embodiments, the further authentication request sent to the third NNF also includes the second indication. In other variants, the further authentication request sent to the third NNF implicitly indicates that the UE should be authenticated for accessing the first access network and for registration with the communications network.

In some of these embodiments, the further authentication request also includes an address associated with the first NNF.

In some embodiments, the authentication request is an EAP Response/Identity message and the authentication response is an EAP-Success message. In some embodiments, the second NNF is combined with the first NNF. In other embodiments, the second NNF is separate from the first NNF.

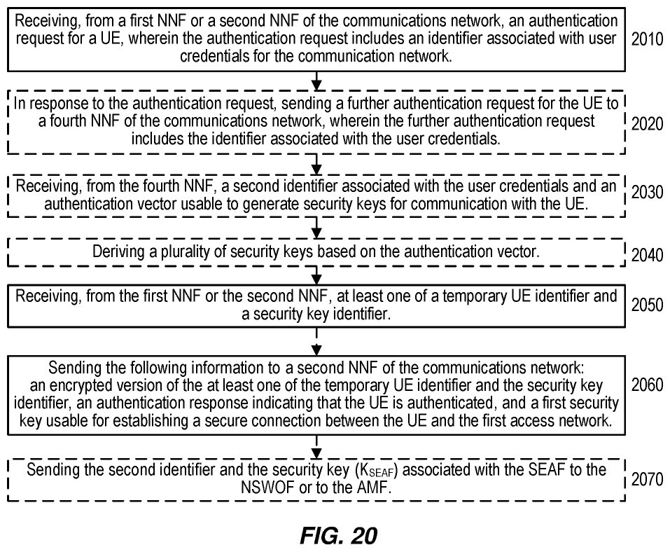

In addition, FIG. 20 illustrates an exemplary method (e.g., procedure) for a third NNF of a communications network (e.g., 5GC), according to various embodiments of the present disclosure. For example, the exemplary method shown in FIG. 20 can be performed by an AUSF (or a network node hosting the same or similar functionality) such as described elsewhere herein.

The exemplary method can include the operations of block 2010, where the third NNF can receive, from a first NNF or a second NNF of the communications network, an authentication request for a UE. The authentication request includes an identifier associated with user credentials for the communication network. The exemplary method can also include the operations of block 2050, where the third NNF can receive, from the first NNF or the second NNF, at least one of a temporary UE identifier and a security key identifier. The exemplary method can also include the operations of block 2060, where the third NNF can send the following information to a second NNF of the communications network:
an encrypted version of the at least one of the temporary UE identifier and the security key identifier,
an authentication response indicating that the UE is authenticated, and
a first security key usable for establishing a secure connection between the UE and the first access network.

In some embodiments, the exemplary method can also include the following operations, labelled with corresponding block numbers:
(2020) in response to the authentication request, sending a further authentication request for the UE to a fourth NNF of the communications network, wherein the further authentication request includes the identifier associated with the user credentials;
(2030) receiving, from the fourth NNF, a second identifier associated with the user credentials and an authentication vector usable to generate security keys for communication with the UE; and
(2040) deriving the following based on the authentication vector: a first security key usable for establishing a secure connection between the UE and the first access network, a security key (K_{SEAF}) associated with a security anchor function (SEAF) of the communications network, and a security key associated with the third NNF.

In some of these embodiments, the identifier associated with user credentials is a SUCI and the second identifier associated with user credentials is a SUPI.

In some of these embodiments, the communications network is a 5G network, the temporary UE identifier is a 5G GUTI, the security key identifier is a ngKSI, the first NNF is an NSWOF, the second NNF is an AMF, the third NNF is an AUSF, and the fourth NNF is a UDM function. In some variants of these embodiments, the first access network is one of the following: a trusted wireless local area network (WLAN), a trusted non-3GPP access network, or a non-trusted non-3GPP access network.

In some variants of these embodiments, the authentication request and the at least one of the temporary UE identifier and the security key identifier are received from the AMF (e.g., in blocks 2010 and 2050) and the information is sent to the AMF (e.g., in block 2060).

In other variants of these embodiments, the authentication request is received from the NSWOF (e.g., in block 2010), the at least one of the temporary UE identifier and the security key identifier is received from the AMF (e.g., in block 2050), and the information is sent to the NSWOF (e.g., in block 2060). For example, the authentication request also includes an address of the AMF, and the at least one of the temporary UE identifier and the security key identifier is retrieved from the address of the AMF.

In other variants of these embodiments, the authentication request and the at least one of the temporary UE identifier and the security key identifier are received from the NSWOF (e.g., in blocks 2010 and 2050), and the information is sent to the NSWOF (e.g., in block 2060). In some further variants, the exemplary method can also include the operations of block 2070, where the third NNF (e.g., AUSF) can send the second identifier and the security key (K_{SEAF}) associated with the SEAF to the NSWOF or to the AMF.

In some embodiments, the first security key is a master session key (MSK). In some embodiments, the authentication request indicates that the UE should be authenticated for accessing a first access network and for registration with the communications network, based on one of the following: implicitly, or by including an explicit indication. In such case, the authentication response indicates that the UE is authenticated in accordance with the authentication request.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

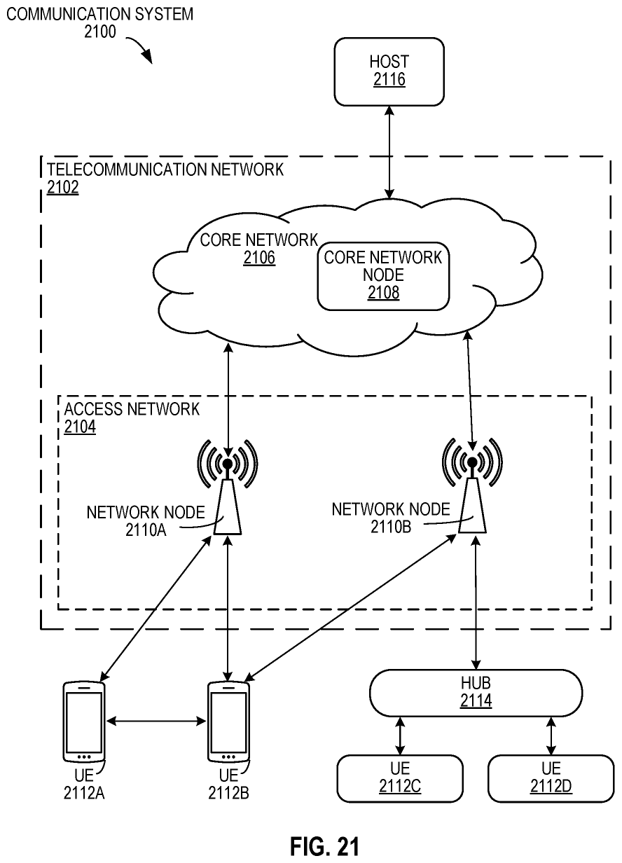

FIG. 21 shows an example of a communication system 2100 in accordance with some embodiments. In this example, communication system 2100 includes a telecommunication network 2102 that includes an access network 2104 (e.g., RAN) and a core network 2106, which includes one or more core network nodes 2108. Access network 2104 includes one or more access network nodes, such as network nodes 2110a-b (one or more of which may be generally referred to as network nodes 2110), or any other similar 3GPP access node or non-3GPP access point. Network nodes 2110 facilitate direct or indirect connection of user UEs, such as by connecting

UEs 2112a-d (one or more of which may be generally referred to as UEs 2112) to core network 2106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 2100 may include any number of wired or wireless networks, network nodes, UEs, and/or any other components or systems that may facilitate or participate in the communication of data and/or signals whether via wired or wireless connections. Communication system 2100 may include and/or interface with any type of communication, telecommunication, data, cellular, radio network, and/or other similar type of system.

UEs 2112 may be any of a wide variety of communication devices, including wireless devices arranged, configured, and/or operable to communicate wirelessly with network nodes 2110 and other communication devices. Similarly, network nodes 2110 are arranged, capable, configured, and/or operable to communicate directly or indirectly with UEs 2112 and/or with other network nodes or equipment in telecommunication network 2102 to enable and/or provide network access, such as wireless network access, and/or to perform other functions, such as administration in telecommunication network 2102.

In the depicted example, core network 2106 connects network nodes 2110 to one or more hosts, such as host 2116. These connections may be direct or indirect via one or more intermediary networks or devices. In other examples, network nodes may be directly coupled to hosts. Core network 2106 includes one or more core network nodes (e.g., 2108) that are structured with hardware and software components. Features of these components may be substantially similar to those described with respect to the UEs, network nodes, and/or hosts, such that the descriptions thereof are generally applicable to the corresponding components of core network node 2108.

Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 2116 may be under the ownership or control of a service provider other than an operator or provider of access network 2104 and/or telecommunication network 2102, and may be operated by the service provider or on behalf of the service provider. Host 2116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 2100 of FIG. 21 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 2102 is a cellular network that implements 3GPP standardized features. Accordingly, telecommunication network 2102 may support network slicing to provide different logical networks to different devices that are connected to telecommunication network 2102. For example, telecommunication network 2102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 2112 are configured to transmit and/or receive information without direct human interaction. For instance, a UE may be designed to transmit information to access network 2104 on a predetermined schedule, when triggered by an internal or external event, or in response to requests from access network 2104. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 2114 communicates with access network 2104 to facilitate indirect communication between one or more UEs (e.g., UE 2112c and/or 2112d) and network nodes (e.g., network node 2110b). In some examples, hub 2114 may be a controller, router, content source and analytics, or any of the other communication devices described herein regarding UEs. For example, hub 2114 may be a broadband router enabling access to core network 2106 for the UEs.

As another example, hub 2114 may be a controller that sends commands or instructions to one or more actuators in the UEs. Commands or instructions may be received from the UEs, network nodes 2110, or by executable code, script, process, or other instructions in hub 2114. As another example, hub 2114 may be a data collector that acts as temporary storage for UE data and, in some embodiments, may perform analysis or other processing of the data. As another example, hub 2114 may be a content source. For example, for a UE that is a VR headset, display, loudspeaker or other media delivery device, hub 2114 may retrieve VR assets, video, audio, or other media or data related to sensory information via a network node, which hub 2114 then provides to the UE either directly, after performing local processing, and/or after adding additional local content. In still another example, hub 2114 acts as a proxy server or orchestrator for the UEs, in particular in if one or more of the UEs are low energy IoT devices.

Hub 2114 may have a constant/persistent or intermittent connection to network node 2110b. Hub 2114 may also allow for a different communication scheme and/or schedule between hub 2114 and UEs (e.g., UE 2112c and/or 2112d), and between hub 2114 and core network 2106. In other examples, hub 2114 is connected to core network 2106 and/or one or more UEs via a wired connection. Moreover, hub 2114 may be configured to connect to an M2M service provider over access network 2104 and/or to another UE over a direct connection. In some scenarios, UEs may establish a wireless connection with network nodes 2110 while still connected via hub 2114 via a wired or wireless connection. In some embodiments, hub 2114 may be a dedicated hub—that is, a hub whose primary function is to route communications to/from the UEs from/to network node 2110b. In other embodiments, hub 2114 may be a non-dedicated hub-that is, a device which is capable of operating to route communications between the UEs and network node 2110b, but which is additionally capable of operating as a communication start and/or end point for certain data channels.

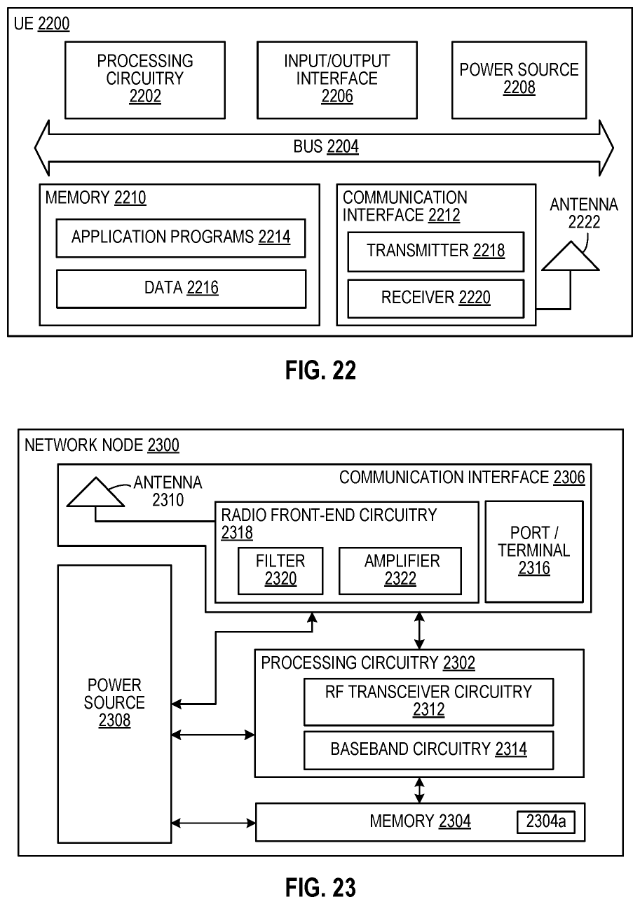

FIG. 22 shows a UE 2200 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 2200 includes processing circuitry 2202 that is operatively coupled via bus 2204 to input/output interface 2206, power source 2208, memory 2210, communication interface 2212, and/or any other component, or any combination thereof. Certain UEs may utilize all or a subset of the components shown in FIG. 22. The level of integration between the components may vary from one UE to another UE. Further, certain UEs may contain multiple instances of a component, such as multiple processors, memories, transceivers, transmitters, receivers, etc.

Processing circuitry 2202 is configured to process instructions and data and may be configured to implement any sequential state machine operative to execute instructions stored as machine-readable computer programs in memory 2210. Processing circuitry 2202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 2202 may include multiple central processing units (CPUs).

In the example, input/output interface 2206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 2200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 2208 is structured as a battery or battery pack. Other types of power sources, such as an external power source (e.g., an electricity outlet), photovoltaic device, or power cell, may be used. Power source 2208 may further include power circuitry for delivering power from power source 2208 itself, and/or an external power source, to the various parts of UE 2200 via input circuitry or an interface such as an electrical power cable. Delivering power may be, for example, for charging of power source 2208. Power circuitry may perform any 15 formatting, converting, or other modification to the power from power source 2208 to make the power suitable for the respective components of UE 2200 to which power is supplied.

Memory 2210 may be or be configured to include memory such as random access memory (RAM), read-only memory (ROM), programmable read-only memory (PROM), erasable 20 programmable read-only memory (EPROM), electrically erasable programmable read-only memory (EEPROM), magnetic disks, optical disks, hard disks, removable cartridges, flash drives, and so forth. In one example, memory 2210 includes one or more application programs 2214, such as an operating system, web browser application, a widget, gadget engine, or other application, and corresponding data 2216. Memory 2210 may store, for use by UE 2200, any of a variety of various operating systems or combinations of operating systems.

Memory 2210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 2210 may allow UE 2200 to access instructions, application programs and the like, stored on transitory or non-transitory memory media, to off-load data, or to upload data. An article of manufacture, such as one utilizing a communication system may be tangibly embodied as or in memory 2210, which may be or comprise a device-readable storage medium.

Processing circuitry 2202 may be configured to communicate with an access network or other network using communication interface 2212. Communication interface 2212 may comprise one or more communication subsystems and may include or be communicatively coupled to an antenna 2222. Communication interface 2212 may include one or more transceivers used to communicate, such as by communicating with one or more remote transceivers of another device capable of wireless communication (e.g., another UE or a network node in an access network). Each transceiver may include transmitter 2218 and/or receiver 2220 appropriate to provide network communications (e.g., optical, electrical, frequency allocations, and so forth). Moreover, transmitter 2218 and receiver 2220 may be coupled to one or more antennas (e.g., 2222) and may share circuit components, software or firmware, or alternatively be implemented separately.

In the illustrated embodiment, communication functions of communication interface 2212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 2200 shown in FIG. 22.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment 25 that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 23 shows a network node 2300 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 2300 includes processing circuitry 2302, memory 2304, communication interface 2306, and power source 2308. Network node 2300 may be composed of multiple physically separate components (e.g., a NodeB component and a RNC component, or a BTS component and a BSC component, etc.), which may each have their own respective components. In certain scenarios in which network node 2300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 2300 may be configured to support multiple radio access technologies (RATs). In such embodiments, some components may be duplicated (e.g., separate memory 2304 for different RATs) and some components may be reused (e.g., a same antenna 2310 may be shared by different RATs). Network node 2300 may also include multiple sets of the various illustrated components for different wireless technologies integrated into network node 2300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2300.

Processing circuitry 2302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2300 components, such as memory 2304, to provide network node 2300 functionality.

In some embodiments, processing circuitry 2302 includes a system on a chip (SOC). In some embodiments, processing circuitry 2302 includes one or more of radio frequency (RF) transceiver circuitry 2312 and baseband processing circuitry 2314. In some embodiments, RF transceiver circuitry 2312 and baseband processing circuitry 2314 may be on separate chips (or sets of chips), boards, or units, such as radio units and digital units. In alternative embodiments, part or all of RF transceiver circuitry 2312 and baseband processing circuitry 2314 may be on the same chip or set of chips, boards, or units.

Memory 2304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 2302. Memory 2304 may store any suitable instructions, data, or information, including a computer program, software, an application including one or more of logic, rules, code, tables, and/or other instructions (collectively denoted computer program 2304a, which may be in the form of a computer program product) capable of being executed by processing circuitry 2302 and utilized by network node 2300. Memory 2304 may be used to store any calculations made by processing circuitry 2302 and/or any data received via communication interface 2306. In some embodiments, processing circuitry 2302 and memory 2304 is integrated.

Communication interface 2306 is used in wired or wireless communication of signaling and/or data between a network node, access network, and/or UE. As illustrated, communication interface 2306 comprises port(s)/terminal(s) 2316 to send and receive data, for example to and from a network over a wired connection. Communication interface 2306 also includes radio front-end circuitry 2318 that may be coupled to, or in certain embodiments a part of, antenna 2310. Radio front-end circuitry 2318 comprises filters 2320 and amplifiers 2322. Radio front-end circuitry 2318 may be connected to antenna 2310 and processing circuitry 2302. The radio front-end circuitry may be configured to condition signals communicated between antenna 2310 and processing circuitry 2302. Radio front-end circuitry 2318 may receive digital data that is to be sent out to other network nodes or UEs via a wireless connection. Radio front-end circuitry 2318 may convert the digital data into a radio signal having the appropriate channel and bandwidth parameters using a combination of filters 2320 and/or amplifiers 2322. The radio signal may then be transmitted via antenna 2310. Similarly, when receiving data, antenna 2310 may collect radio signals which are then converted into digital data by radio front-end circuitry 2318. The digital data may be passed to processing circuitry 2302. In other embodiments, the communication interface may comprise different components and/or different combinations of components.

In certain alternative embodiments, network node 2300 does not include separate radio front-end circuitry 2318, instead, processing circuitry 2302 includes radio front-end circuitry and is connected to antenna 2310. Similarly, in some embodiments, all or some of the RF transceiver circuitry 2312 is part of communication interface 2306. In still other embodiments, communication interface 2306 includes one or more ports or terminals 2316, radio front-end circuitry 2318, and the RF transceiver circuitry 2312, as part of a radio unit (not shown), and communication interface 2306 communicates with baseband processing circuitry 2314, which is part of a digital unit (not shown).

Antenna 2310 may include one or more antennas, or antenna arrays, configured to send and/or receive wireless signals. Antenna 2310 may be coupled to radio front-end circuitry 2318 and may be any type of antenna capable of transmitting and receiving data and/or signals wirelessly. In certain embodiments, antenna 2310 is separate from network node 2300 and connectable to network node 2300 through an interface or port.

Antenna 2310, communication interface 2306, and/or processing circuitry 2302 may be configured to perform any receiving operations and/or certain obtaining operations described herein as being performed by the network node. Any information, data and/or signals may be received from a UE, another network node and/or any other network equipment. Similarly, antenna 2310, communication interface 2306, and/or processing circuitry 2302 may be configured to perform any transmitting operations described herein as being performed by the network node. Any information, data and/or signals may be transmitted to a UE, another network node and/or any other network equipment.

Power source 2308 provides power to the various components of network node 2300 in a form suitable for the respective components (e.g., at a voltage and current level needed for each respective component). Power source 2308 may further comprise, or be coupled to, power management circuitry to supply the components of network node 2300 with power for performing the functionality described herein. For example, network node 2300 may be connectable to an external power source (e.g., the power grid, an electricity outlet) via an input circuitry or interface such as an electrical cable, whereby the external power source supplies power to power circuitry of power source 2308. As a further example, power source 2308 may comprise a source of power in the form of a battery or battery pack which is connected to, or integrated in, power circuitry. The battery may provide backup power should the external power source fail.

Embodiments of network node 2300 may include additional components beyond those shown in FIG. 23 for providing certain aspects of the network node's functionality, including any of the functionality described herein and/or any functionality necessary to support the subject matter described herein. For example, network node 2300 may include user interface equipment to allow input of information into network node 2300 and to allow output of information from network node 2300. This may allow a user to perform diagnostic, maintenance, repair, and other administrative functions for network node 2300.

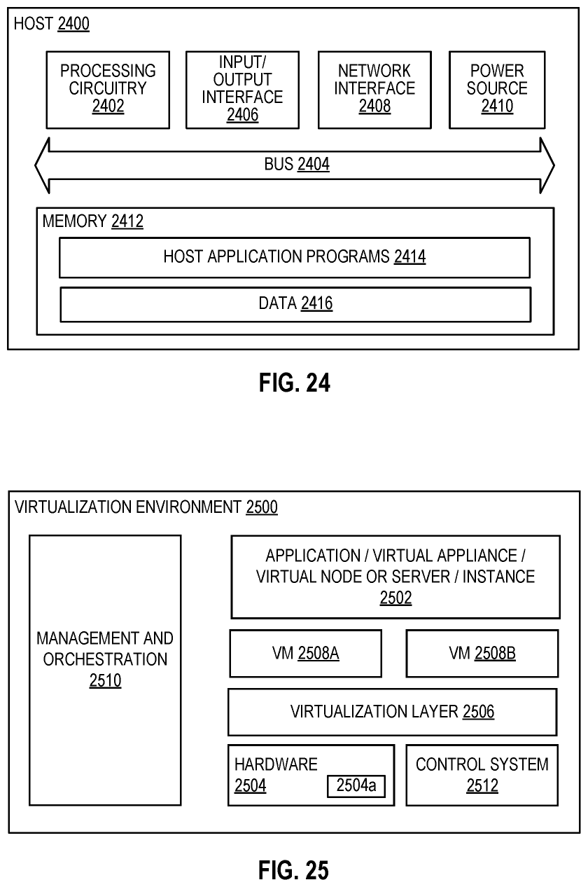

FIG. 24 is a block diagram of a host 2400, which may be an embodiment of host 2116 of FIG. 21, in accordance with various aspects described herein. As used herein, host 2400 may be or comprise various combinations hardware and/or software, including a standalone server, a blade server, a cloud-implemented server, a distributed server, a virtual machine, container, or processing resources in a server farm. Host 2400 may provide one or more services to one or more UEs.

Host 2400 includes processing circuitry 2402 that is operatively coupled via a bus 2404 to input/output interface 2406, network interface 2408, power source 2410, and memory 2412. Other components may be included in other embodiments. Features of these components may be substantially similar to those described with respect to the devices of previous figures, such as FIGS. 22 and 23, such that the descriptions thereof are generally applicable to the corresponding components of host 2400.

Memory 2412 may include one or more computer programs including one or more host application programs 2414 and data 2416, which may include user data, e.g., data generated by a UE for host 2400 or data generated by host 2400 for a UE. Embodiments of host 2400 may utilize only a subset or all of the components shown. Host application programs 2414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 2414 may also provide for user authentication and licensing checks and may periodically report health, routes, and content availability to a central node, such as a device in or on the edge of a core network. Accordingly, host 2400 may select and/or indicate a different host for over-the-top services for a UE. Host application programs 2414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 25 is a block diagram illustrating a virtualization environment 2500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2502 (which may alternatively be called software instances, virtual appliances, network functions, virtual nodes, virtual network functions, etc.) are run in the virtualization environment 2500 to implement some of the features, functions, and/or benefits of some of the embodiments disclosed herein.

Hardware 2504 includes processing circuitry, memory that stores software and/or instructions (collectively denoted computer program 2504a, which may be in the form of a computer program product) executable by hardware processing circuitry, and/or other hardware devices as described herein, such as a network interface, input/output interface, and so forth. Software may be executed by the processing circuitry to instantiate one or more virtualization layers 2506 (also referred to as hypervisors or virtual machine monitors (VMMs)), provide VMs 2508a-b (one or more of which may be generally referred to as VMs 2508), and/or perform any of the functions, features and/or benefits described in relation with some embodiments described herein. Virtualization layer 2506 may present a virtual operating platform that appears like networking hardware to the VMs 2508.

VMs 2508 comprise virtual processing, virtual memory, virtual networking or interface and virtual storage, and may be run by a corresponding virtualization layer 2506. Different embodiments of the instance of virtual appliance 2502 may be implemented on one or more of VMs 2508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 2508 may be a software implementation of a physical machine that runs programs as if they were executing on a physical, non-virtualized machine. Each VM 2508, and that part of hardware 2504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2508 on top of hardware 2504 and corresponds to application 2502.

Hardware 2504 may be implemented in a standalone network node with generic or specific components. Hardware 2504 may implement some functions via virtualization. Alternatively, hardware 2504 may be part of a larger cluster of hardware (e.g., such as in a data center or CPE) where many hardware nodes work together and are managed via management and orchestration 2510, which, among others, oversees lifecycle management of applications 2502. In some embodiments, hardware 2504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2512 which may alternatively be used for communication between hardware nodes and radio units.

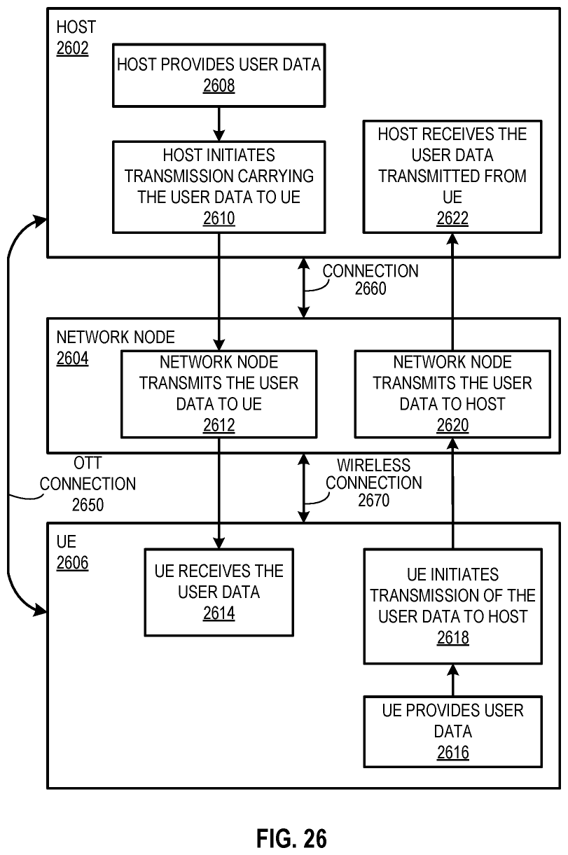

FIG. 26 shows a communication diagram of a host 2602 communicating via a network node 2604 with a UE 2606 over a partially wireless connection in accordance with some embodiments. Example implementations, in accordance with various embodiments, of the UE (such as a UE 2112a of FIG. 21 and/or UE 2200 of FIG. 22), network node (such as network node 2110a of FIG. 21 and/or network node 2300 of FIG. 23), and host (such as host 2116 of FIG. 21 and/or host 2400 of FIG. 24) discussed in the preceding paragraphs will now be described with reference to FIG. 26.

Like host 2400, embodiments of host 2602 include hardware, such as a communication interface, processing circuitry, and memory. Host 2602 also includes software, which is stored in or accessible by host 2602 and executable by the processing circuitry. The software includes a host application that may be operable to provide a service to a remote user, such as UE 2606 connecting via an over-the-top (OTT) connection 2650 extending between UE 2606 and host 2602. In providing the service to the remote user, a host application may provide user data which is transmitted using OTT connection 2650.

Network node 2604 includes hardware enabling it to communicate with host 2602 and UE 2606. Connection 2660 may be direct or pass through a core network (like core network 2106 of FIG. 21) and/or one or more other intermediate networks, such as one or more public, private, or hosted networks. For example, an intermediate network may be a backbone network or the Internet.

UE 2606 includes hardware and software, which is stored in or accessible by UE 2606 and executable by the UE's processing circuitry. The software includes a client application, such as a web browser or operator-specific “app” that may be operable to provide a service to a human or non-human user via UE 2606 with the support of host 2602. In host 2602, an executing host application may communicate with the executing client application via OTT connection 2650 terminating at UE 2606 and host 2602. In providing the service to the user, the UE's client application may receive request data from the host's host application and provide user data in response to the request data. OTT connection 2650 may transfer both the request data and the user data. The UE's client application may interact with the user to generate the user data that it provides to the host application through OTT connection 2650.

OTT connection 2650 may extend via a connection 2660 between host 2602 and network node 2604 and via a wireless connection 2670 between network node 2604 and UE 2606 to provide the connection between host 2602 and UE 2606. Connection 2660 and wireless connection 2670, over which OTT connection 2650 may be provided, have been drawn abstractly to illustrate the communication between host 2602 and UE 2606 via network node 2604, without explicit reference to any intermediary devices and the precise routing of messages via these devices.

As an example of transmitting data via OTT connection 2650, in step 2608, host 2602 provides user data, which may be performed by executing a host application. In some embodiments, the user data is associated with a particular human user interacting with UE 2606. In other embodiments, the user data is associated with a UE 2606 that shares data with host 2602 without explicit human interaction. In step 2610, host 2602 initiates a transmission carrying the user data towards UE 2606. Host 2602 may initiate the transmission responsive to a request transmitted by UE 2606. The request may be caused by human interaction with UE 2606 or by operation of the client application executing on UE 2606. The transmission may pass via network node 2604, in accordance with the teachings of the embodiments described throughout this disclosure. Accordingly, in step 2612, network node 2604 transmits to UE 2606 the user data that was carried in the transmission that host 2602 initiated, in accordance with the teachings of the embodiments described throughout this disclosure. In step 2614, UE 2606 receives the user data carried in the transmission, which may be performed by a client application executed on UE 2606 associated with the host application executed by host 2602.

In some examples, UE 2606 executes a client application which provides user data to host 2602. The user data may be provided in reaction or response to the data received from host 2602. Accordingly, in step 2616, UE 2606 may provide user data, which may be performed by executing the client application. In providing the user data, the client application may further consider user input received from the user via an input/output interface of UE 2606. Regardless of the specific manner in which the user data was provided, UE 2606 initiates, in step 2618, transmission of the user data towards host 2602 via network node 2604. In step 2620, in accordance with the teachings of the embodiments described throughout this disclosure, network node 2604 receives user data from UE 2606 and initiates transmission of the received user data towards host 2602. In step 2622, host 2602 receives the user data carried in the transmission initiated by UE 2606.

One or more of the various embodiments improve the performance of OTT services provided to UE 2606 using OTT connection 2650, in which wireless connection 2670 forms the last segment. More precisely, embodiments described herein can provide various benefits and/or advantages useful for OTT services. For example, since only one authentication procedure is needed for a UE, embodiments can reduce the signaling between UE and involved network entities, as well as processing load in UE and involved network entities, relative to conventional techniques that require two authentication procedures. Additionally, embodiments facilitate smaller delay when a UE registers to 5GC since the UE's NAS security context is already available from earlier access-related authentication. By reducing registration delay for users and network signaling/processing resources needed for registration, embodiments improve the delivery of OTT services via WLAN access network, thereby increasing the value of OTT services to end users and service providers.

In an example scenario, factory status information may be collected and analyzed by host 2602. As another example, host 2602 may process audio and video data which may have been retrieved from a UE for use in creating maps. As another example, host 2602 may collect and analyze real-time data to assist in controlling vehicle congestion (e.g., controlling traffic lights).

As another example, host 2602 may store surveillance video uploaded by a UE. As another example, host 2602 may store or control access to media content such as video, audio, VR or AR which it can broadcast, multicast or unicast to UEs. As other examples, host 2602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 2650 between host 2602 and UE 2606, in response to variations in the measurement results. The measurement procedure and/or the network functionality for reconfiguring the OTT connection may be implemented in software and hardware of host 2602 and/or UE 2606. In some embodiments, sensors (not shown) may be deployed in or in association with other devices through which OTT connection 2650 passes; the sensors may participate in the measurement procedure by supplying values of the monitored quantities exemplified above, or supplying values of other physical quantities from which software may compute or estimate the monitored quantities. The reconfiguring of OTT connection 2650 may include message format, retransmission settings, preferred routing etc.; the reconfiguring need not directly alter the operation of network node 2604. Such procedures and functionalities may be known and practiced in the art. In certain embodiments, measurements may involve proprietary UE signaling that facilitates measurements of throughput, propagation times, latency and the like, by host 2602. The measurements may be implemented in that software causes messages to be transmitted, in particular empty or ‘dummy’ messages, using OTT connection 2650 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

1.-83. (canceled)

84. A method for a user equipment (UE) configured to communicate with a communications network via at least a first access network, the method comprising:
without registering with the communications network, receiving from the communications network an authentication-related message that includes the following: an identifier associated with the first access network, and at least one of a temporary UE identifier and a security key identifier;
based on the identifier associated with the first access network, generating a first security key usable for establishing a secure connection with the first access network;
establishing a secure connection with the first access network based on the first security key; and
registering with the communications network based on the at least one of the temporary UE identifier and the security key identifier.

85. The method of claim 84, further comprising, based on the identifier associated with the first access network and the at least one of the temporary UE identifier and the security key identifier, generating one or more second security keys usable for communicating with the communications network without need for further authentication of the UE.

86. The method of claim 85, wherein:
the first security key is a master session key (MSK) or a non-seamless wireless LAN offload (NSWO) key;
the communications network is a fifth-generation (5G) network;
the temporary UE identifier is a 5G globally unique temporary identifier (GUTI);
the security key identifier is a non-access stratum key set identifier (ngKSI); and
the one or more second security keys include K_{AUSF}, K_{SEAF}, and K_{AMF}.

87. The method of claim 86, wherein the first access network is a trusted wireless local area network (WLAN), a trusted non-3GPP access network, or a non-trusted non-3GPP access network.

88. The method of claim 85, wherein registering with the communications network is based on K_{AMF}.

89. The method of claim 84, wherein the authentication-related message is an EAP-Request message or an EAP-Success message.

90. The method of claim 84, further comprising:
sending to the first access network a first authentication message including an identifier associated with user credentials for the communications network; and
receiving from the first access network a second authentication message responsive to the first authentication message.

91. The method of claim 90, wherein one of the following applies:
the first authentication message includes an indication that the UE is requesting authentication for accessing the first access network and for registration with the communications network; or
the second authentication message includes an indication that the communications network is authenticating the UE for accessing the first access network and for registration with the communications network.

92. The method of claim 90, wherein at least one of the following applies:
the first authentication message is an EAP Response/Identity message and the second authentication message is an EAP-Request message; and
the identifier associated with user credentials for the communications network is a subscription concealed identifier (SUCI).

93. A method for a first network node or function (NNF) of a communications network, the method:
receiving, from a user equipment (UE) via a first access network, a first authentication message that includes an identifier associated with user credentials for the communications network;
sending, to a second NNF of the communications network, an authentication request that includes the identifier associated with user credentials for the communications network;
receiving the following information from the second NNF:
at least one of a temporary UE identifier and a security key identifier,
an authentication response indicating that the UE is authenticated, and a first security key usable for establishing a secure connection between the UE and the first access network; and
forwarding the first security key to the first access network and forwarding the at least one of the temporary UE identifier and the security key identifier to the UE via the first access network.

94. The method of claim 93, wherein at least one of the following applies:
the first access network is a trusted wireless local area network (WLAN), a trusted non-3GPP access network, or a non-trusted non-3GPP access network;
the first security key is a master session key (MSK) or a non-seamless wireless LAN offload (NSWO) key;
the at least one of the temporary UE identifier and the security key identifier is received and forwarded in a data parameter of an EAP-Request message, with the data parameter being encrypted and/or integrity protected; and
the first authentication message is an EAP Response/Identity message and the authentication response is an EAP-Success message.

95. The method of claim 93, wherein the authentication request also includes a second indication that the UE should be authenticated for accessing the first access network and for registration with the communications network, and the authentication response indicates that the UE is authenticated in accordance with the second indication.

96. The method of claim 95, wherein the second indication is included in the authentication request based on determining that the UE should be authenticated for accessing the first access network and for registration with the communications network.

97. The method of claim 96, wherein determining that the UE should be authenticated for accessing the first access network and for registration with the communications network is based on one of the following:
an indication that the UE is requesting authentication for accessing the first access network and for registration with the communications network, included in the first authentication message; or
local policy of the first NNF that each UE authentication should be for accessing the first access network and for registration with the communications network.

98. The method of claim 97, further comprising, when determining that the UE should be authenticated is based on local policy, sending to the UE via the first access network a third indication that the communications network is authenticating the UE for accessing the first access network and for registration with the communications network.

99. The method of claim 98, wherein the third indication is sent to the UE in a data parameter of an EAP-Request message, with the data parameter being encrypted and/or integrity protected.

100. The method of claim 99, further comprising receiving the EAP-Request message from the second NNF, wherein the received EAP-Request message is forwarded to the UE via the first access network.

101. The method of claim 93, wherein the authentication request sent to the second NNF implicitly indicates that the UE should be authenticated for accessing the first access network and for registration with the communications network.

102. The method of claim 93, wherein:
the communications network is a 5G network;
the temporary UE identifier is a 5G globally unique temporary identifier (GUTI);
the security key identifier is a non-access stratum key set identifier (ngKSI);
the first NNF is a non-seamless wireless LAN offload function (NSWOF); and
the second NNF is one of the following: an access and mobility management function (AMF) separate from the NSWOF, an AMF combined with the NSWOF, or an authentication support function (AUSF).

103. The method of claim 102, wherein the authentication request also includes an address of an AMF that supports registration of the UE with the communications network.

104. A user equipment (UE) configured to communicate with a communications network via at least a first access network, the UE comprising:
communication interface circuitry configured to communicate via the first access network; and
processing circuitry operably coupled to the communication interface circuitry, wherein the processing circuitry and the communication interface circuitry are configured to:
without registering with the communications network, receive from the communications network an authentication-related message that includes the following: an identifier associated with the first access network, and at least one of a temporary UE identifier and a security key identifier;
based on the identifier associated with the first access network, generate a first security key usable for establishing a secure connection with the first access network;
establish a secure connection with the first access network based on the first security key; and
register with the communications network based on the at least one of the temporary UE identifier and the security key identifier.

105. Network equipment configured to implement a first network node or function (NNF) of a communications network, the network equipment comprising:
communication interface circuitry configured to communicate with user equipment (UEs) and with other NNFs of the communications network; and
processing circuitry operably coupled to the communication interface circuitry, wherein the processing circuitry and the communication interface circuitry are configured to:
receive, from a UE via a first access network, a first authentication message that includes an identifier associated with user credentials for the communications network;
send, to a second NNF of the communications network, an authentication request that includes the identifier associated with user credentials for the communications network;
receive the following information from the second NNF:
at least one of a temporary UE identifier and a security key identifier,
an authentication response indicating that the UE is authenticated, and
a first security key usable for establishing a secure connection between the UE and the first access network; and
forward the first security key to the first access network and forward the at least one of the temporary UE identifier and the security key identifier to the UE via the first access network.
